(19) United States
(12) Patent Application Publication
(10) Pub. No.: US 2025/0280432 A1
(43) Pub. Date: Sep. 4, 2025

(54) DCI ENABLED SKIPPING PROCEDURES

(71) Applicant: Oswego Properties LLC, Columbus, NJ (US)

(72) Inventor: Brian Gordaychik, Columbus, NJ (US)

(21) Appl. No.: 19/211,524

(22) Filed: May 19, 2025

Related U.S. Application Data
(63) Continuation of application No. 17/945,635, filed on Sep. 15, 2022.
Application No. 17/945,635 is a continuation of application No. 16/950,369, filed on Nov. 17, 2020, now abandoned.
Application No. 16/950,369 is a continuation of application No. 16/421,034, filed on May 23, 2019, now Pat. No. 10,880,895.
(60) Provisional application No. 62/728,032, filed on Sep. 6, 2018.
(60) Provisional application No. 62/775,342, filed on Dec. 4, 2018.
(60) Provisional application No. 62/800,464, filed on Feb. 2, 2019.
(60) Provisional application No. 62/830,478, filed on Apr. 7, 2019.
(60) Provisional application No. 62/677,016, filed on May 27, 2018.

(51) Int. Cl. H04W 72/51; H04L 1/00; H04L 1/08; H04L 1/1607; H04L 1/1829; H04L 1/1867; H04L 5/00; H04L 67/125; H04W 8/22; H04W 28/16; H04W 52/18; H04W 52/54; H04W 52/58; H04W 72/044; H04W 72/23; H04W 74/0833

(52) U.S. Cl. CPC H04W 72/51; H04L 1/0013; H04L 1/08; H04L 1/1671; H04L 1/1835; H04L 1/1854; H04L 1/1887; H04L 1/1896; H04L 5/0058; H04L 67/125; H04W 8/22; H04W 28/16; H04W 52/18; H04W 52/54; H04W 52/58; H04W 72/044; H04W 72/23; H04W 74/0833

(57) ABSTRACT

A method performed by a user equipment (UE) may comprise receiving a first synchronization signal, from a base station, and decoding PBCH by way of the first synchronization signal and receiving RRC information, from the base station, wherein the RRC information indicates information about a second synchronization signal which is different from the first synchronization signal. The method may further comprise determining a periodicity of the second synchronization signal based on the RRC information and receiving, on a secondary cell (SCELL) of the base station, the second synchronization signal in accordance with the periodicity. The UE may receive a measurement gap configuration and first downlink control information (DCI) that schedules resources over more than one set of frequency domain resources. The UE may skip at least one measurement gap due at least in part to a higher priority signal in accordance with an offset from the first DCI.

### CROSS REFERENCE TO RELATED APPLICATIONS

This application is a continuation of U.S. application Ser. No. 17/945,635 filed Sep. 15, 2022 which is a continuation of U.S. application Ser. No. 16/950,369 filed Nov. 17, 2020 which is a continuation of U.S. application Ser. No. 16/421,034 filed May 23, 2019, which issued as U.S. Pat. No. 10,880,895 on Dec. 29, 2020, which claims the benefit of U.S. Provisional Application Ser. No. 62/677,016 filed on May 27, 2018, U.S. Provisional Application Ser. No. 62/728,032 filed on Sep. 6, 2018, U.S. Provisional Application Ser. No. 62/775,342 filed on Dec. 4, 2018, U.S. Provisional Application Ser. No. 62/800,464 filed on Feb. 2, 2019 and U.S. Provisional Application Ser. No. 62/830,478 filed on Apr. 7, 2019, the contents of each of which are hereby incorporated by reference herein.

### SUMMARY

A method performed by a user equipment (UE) may comprise receiving a first synchronization signal, from a base station, and decoding PBCH by way of the first synchronization signal and receiving RRC information, from the base station, wherein the RRC information indicates information about a second synchronization signal which is different from the first synchronization signal. The method may further comprise determining a periodicity of the second synchronization signal based on the RRC information and receiving, on a secondary cell (SCELL) of the base station, the second synchronization signal in accordance with the periodicity. The UE may receive a measurement gap configuration and first downlink control information (DCI) that schedules resources over more than one set of frequency domain resources. The first DCI may comprise a single bit flag which indicates skipping of a set of symbols. The UE may skip at least one measurement gap due at least in part to a higher priority signal in accordance with an offset from the first DCI.

### BRIEF DESCRIPTION OF THE DRAWINGS

FIG. 1 is an illustration of an embodiment in which a capability identifier (ID) is included in an attach request message;

FIG. 2 is an illustration of example transmit power control (TPC) values;

FIG. 3 is a table of example wake up signal duration settings;

FIG. 4 is a message diagram which illustrates a method for determining a transmit power level for non-orthogonal multiple access (NOMA) communications among stations (STAs) and access points (APs);

FIG. 5 is a random access channel (RACH) occasion table;

FIG. 6 is a standard 802.11ay draft procedure in which MU-MIMO responders transmit clear to send responses a short interframe spacing (SIFS) after known initiator transmissions;

FIG. 7 is an illustration of an exemplary flight pattern;

FIG. 8 is an illustration of a line of sight concept;

FIG. 9 is another illustration of the line of sight concept;

FIG. 10 is a flowchart for receiving resources for non-orthogonal multiple access (NOMA) transmissions by a user equipment (UE).

### DETAILED DESCRIPTION

In next generation radio technologies, a user equipment (UE) capability identifier (ID) may specify or indicate capabilities which are common across various devices and device types. This capability ID may be signaled or used in a registration request or other message to a network, for example during initial access, handover, association, random access or the like. In response to a registration request, which may or may not include a capabilities transmission, the UE may receive a registration area configuration with an indication that capabilities are acceptable for a registered area. All registered capabilities or a portion of the registered capabilities may be accepted or acceptable by the network. A network, for example, an Access and Mobility Management Function (AMF) and a next generation Node B (gNB) may send a capability enquiry message to the UE for responding, by the UE, with the capability information, i.e. the capability ID. The network may assign a new capability to the UE once the UE is determined to have an enhanced capability.

Support for a capability identifier may itself be a capability of a UE which may need to be reported prior to the capability identifier. There may be common sets of capabilities defined, for example, using a database or lookup table (LUT) method which provides an index to a particular capability identifier based on a type, classification, code, capability or the like. There may be a lookup performed, by the UE for example using Huffman coding, or LZW coding etc. A more typical cellular based coding may be employed, for example, a gold sequence may be used to signify levels of a particular capability. Using a gold sequence, a particular sequence of bits may refer to the capability, while the shift in the sequence refers to a capability version. A coding or hashing of a portion of the capability identifier may be indicated by a manufacturer specific or public land mobile network (PLMN) specific portion of the capability identifier. The ID may be sent in RRC, MAC, NAS or other signaling protocols. A DCI may indicate resources for the transmission of the capability ID. One or more capability IDs may represent access stratum vs. non access stratum capabilities. In an embodiment, a capability ID may be included in a MAC header, for example, coded in a duration/ID field.

A hash of the capabilities may be performed via a secure hash algorithm (SHA) hash or another secure hash. A UE may support a capability to compress information before transmission or decompress information after reception. The compression may be used to compress/decompress the capability ID itself. The capability identifier may be compressed, for example at a radio resource control (RRC), Packet Data Convergence Protocol (PDCP) layer or other layer and may also be segmented if necessary. A system information block (SIB) may indicate a type of compression used and the UE may respond with a compressed capability ID according to the compression type. Compression may be lossy compression or lossless compression. One base station may provide lossy information compression while another provides less lossy or lossless compression information. An ID may be transmitted along with other UE parameters including a unique UE identifier. A UE ID may be permanent or be comprised of a permanent portion and a temporary portion, for example, similar to a changing RSA code. A UE ID may comprise a portion of an International Mobile Equipment Identity (IMEI), for example, a TAC/FAC. The UE ID may contain a checksum.

A device may or may not recognize a UE capability ID. For example a base station, relay TRP etc. may not have seen a newer device which has a recent capability ID. The base station may request a capability table from the UE so that the device can update it set of capabilities. Alternatively, the device may reach out to a network entity, for example, an HLR etc for an updated table to match the transmitted capability ID of the UE. Capability IDs may be stored in the RAN or core network. Capability ID may be reported as a delta from a previous capability ID.

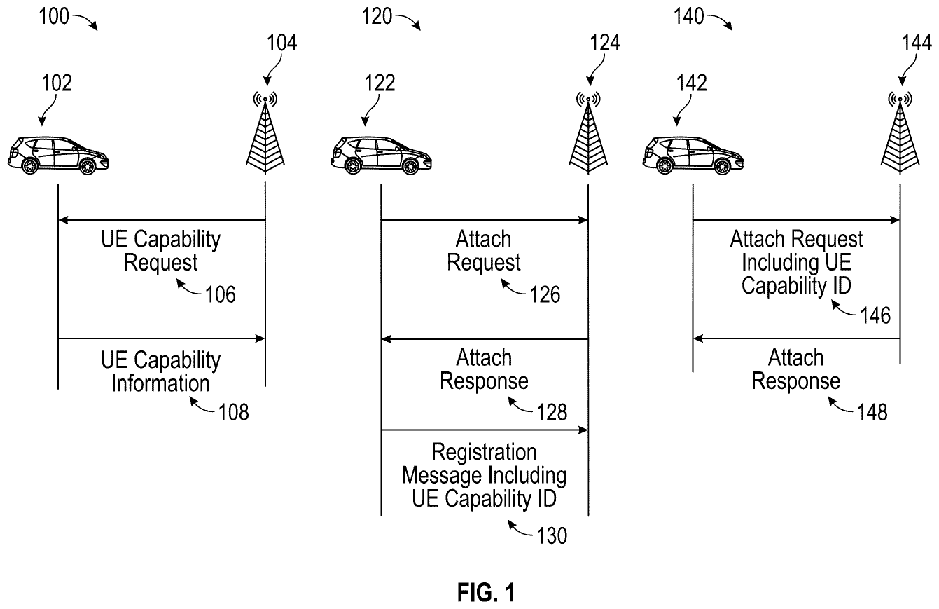

FIG. 1 illustrates embodiments 100, 120, 140 in which a capability ID may be provided to a network. In a first embodiment 100, a UE 102, for example a vehicle, may receive a UE capability request 106 from a gNB 104. In response, the UE 102 may provide a UE capability information message 108 including a UE capability ID to the gNB 104. In a second embodiment 120, a UE 122 may send an attach request 126 to a gNB 124. An attach response 128 sent from the gNB 124 to the UE 122 may or may not request a capability ID. The UE 122 may respond with a registration message including a UE capability ID 130. In a third embodiment 140, a UE 142 may transmit an attach request message 146 including a UE capability ID. The gNB 144 may respond with an attach response 148 indicating acceptance of the UE capabilities.

In some examples, the capability identifier may be multi-format capable, for example, it may include a base indicator plus additional features or capabilities. In one example, a 5G release version may be a base indication and feature characteristics may be appended. The base features may be considered mandatory while add on capabilities are considered optional. Base support may include base subcarrier spacings of 15/30/60/120 khz subcarrier spacing and thus may not need to be incorporated in a capability identifier. Support for other subcarrier spacing options may be delineated as an offset or indicator from the base spacing. Other features may include amount of baseband processing memory (which may be applicable to carrier aggregation); support for SCells with or without typical NR SS/PBCH block occurring with a 16 frame period, a maximum number of MIMO layers, RX beam switching and support for basic or advanced CSI feedback type(s). CSI types may include zero padding (ZP) and nonzero padding (NZP) CSI. A number of ZP or NZP elements may be reported prior to, simultaneously with or following a payload transmission. Before or after an RX beam is switched, the UE may transmit CSI feedback. As used herein, the term SCell may refer to a secondary cell, for example, a supplementary uplink cell which operates in addition to a PCell or regular uplink cell. Cells may be organized into cell groups which each have primary cell and zero or more secondary cells.

In one embodiment, a UE may detect a synchronization signal (SS) and attempt to determine whether to initiate random access on a cell based on the SS or contents of the PBCH block. The UE may due this at initial access, upon handover, or the like in accordance with based on pre-indicated or preconfigured frequencies. The UE may receive a MIB or SIB before handover and before initiating random access. It may be that the MIB or SIB contains information for aiding in random access. It could also be that the MIB or SIB provide other information for the UE.

A UE may have one capability supported for operation using a PCELL or master cell. The UE may have another capability supported for a SCELL or secondary cell. The same may be true for a cell of another technology or frequency. A cell may be divided into a number of parts, for example, based on direction, frequency, one or more TRPs or the like. A UE may report capabilities which are different for uplink and downlink, the supported frequency or the like. In the downlink, a UE may support a wider array of frequencies than the downlink, i.e. the uplink may only support a narrow band. For example, the UE may support limited DCI formats including narrowband DCI formats denoted as Nx based formats, for example, preexisting formats including: N0, N1, N2 as well as new formats including N3, N4 and N5 which may be defined as providing parameters and control information herein. Each may be provided to UEs which may have the capability to support the format.

A UE using a numerology and particular subcarrier spacing may receive a demodulation reference signal (DMRS) and may also transmit a DMRS in the uplink. The DMRS may be UE specific and the UE may receive multiple (or transmit) multiple DMRSs which are separated by frequency, code, beam or the like. In this way, multiple orthogonal DMRS signals may be received (or transmitted) in MIMO scenarios. Some DMRS may be narrowband, some may be wideband. Any one of the signals or parameters transmitted or received herein may be transmitted with a specific offset from DMRS. This may include control and/or data information for example, SIBs. In one embodiment, the UE may group DMRS on a per base station or per TRP basis. In this way, multiple DMRS per TRP may share a parameter or may be initialized in a first way. Multiple DMRS per another TRP may share a different parameter or may be initialized in a second way. The initialization may be according to an initialization sequence. The groups may include uplink and downlink signals or may not be in accordance with an initialization sequence, for example, groups may be based on UE ID, location or capability. A UE may indicate a capability of supporting a DMRS type or a sequence type. This may aid in backwards capability wherein DMRS are not provided to UEs who cannot receive them. Groups of UEs may be assigned to a same carrier, same beam, same resource, same resource block, same resource block group (RBG) or the like. Groups may be determined based on location, capability or the like. DCI may provide an indication of resource unit, resource block or resource block group (RBG) for uplink or downlink purposes, based on a capability indication.

DCI formats may also indicate the priority of the UCI information or a priority of any other indicated UL/DL information. For example, eMBB transmission may employ a different UCI format than URLLC transmissions. Information regarding the UCI format, for example, a number of symbols used may be provided in DCI or other higher layer signaling.

Dropping of a transmission or reception may be based on a QoS; whether a grant is configured dynamically vs. a periodic transmission; grant-free vs. grant based, traffic type, resources utilized for the transmission, whether only a portion of the transmission/reception may be dropped as opposed to all; time based, for example, an early grant vs. later grant; resource based, for example earlier resources vs later resources; logical channel prioritization based on one or more logical channel identifiers (LCIDs) and/or based on backhaul and/or radio link control (RLC) channel prioritization; whether or not multiplexing of control information can be performed. The UE may receive a prioritization for dropping transmissions in a DCI, MAC or higher layer signaling. Priority rules may be received in RRC or MAC signaling and provided to the PHY layer for determining transmission priority and dropping rules.

Various different UE classes may implement dropping differently. In one embodiment, one UE class may merely select one of a first received grant and a second received grant to be transmitted and the another one dropped. For example, a second grant may be transmitted on, while the first grant dropped even though they were both scheduled on same or overlapping resources. Multiple configured grants may be active and, in an embodiment, no transmissions may be dropped. Dropping may be performed in accordance with or based on a rank indicator or rank. In one embodiment, instead of dropping all CSI, the UE may drop a portion of the CSI. For example, the CSI reported may only be a subset of determined coefficients, i.e. the CSI may comprise bits of the determined coefficients. A trigger for the CSI report may be received via DCI via a wake up signal.

A gNB may inform a UE of a no transmission instance using a DCI format 2_1. A DCI format 2_0 may indicate slot format. One DCI may indicate resources for an initial transmission, while another DCI format indicates resources for a retransmission. Or a same format may indicate transmission and retransmission resources. Some DCI formats may not indicate resources for retransmission or subsequent transport blocks. DCI formats may provide an indication that the resources used for a transmission/retransmission are flexible in nature, for example, frame and subframe length may be flexible. Flexible may also refer to the way in which a symbol or slot is dedicated for transmission. One symbol may be UL, DL or flexible denoted.

A DCI format may be determined, at reception time, by determining it's size (number of bits, number of symbols used on the PDCCH, number of CCEs or the like). The number of bits or symbols may imply an offset for resources indicated, HARQ resources used, etc. The resources of which the PDCCH are placed on may also indicate values for anyone of the parameters herein. In this way, there need not necessarily be an indicator to indicate the particular DCI format. Resources for monitoring PDCCH may be indicated in DCI. DCIs may be monitored simultaneously.

Some DCI formats may require HARQ transmissions or receptions and may indicate priority levels associated with the HARQ processes or HARQ transmissions based on a HARQ process number or identifier. A UE may support no more than a fixed number of HARQ processes, for example, no more than 1, 2, 4, 8, 16 or the like. Others may not, for example, when traffic becomes stale only instants after the failed reception. HARQ transmissions may acknowledge a single received data or may be bundled together to transmit an ACK or NACK of multiple data segments together. The HARQ ACK/NACK transmissions may be on sub slot resources indicated in a DCI as an offset from PDSCH or other channel or value. Alternatively, RRC may provide the resources used for HARQ. A UE may just transmit NACKs, rather than ACKs, in an embodiment so that ACK skipping may be employed based on one or more latency requirements and/or priority requirements.

Bundling may be performed using a bit map. This bit map may be transmitted over the physical uplink control channel (PUCCH), physical uplink shared channel (PUSCH) or a combination thereof, i.e. a portion of a map on PUCCH and a portion of the map on PUSCH. The bitmap may include CSI related information or may be multiplexed or transmitted with CSI. The maximum number of HARQ ACKs which a UE is capable of supporting may be based on UE capability or may be in accordance with numerology, a number of configured repetitions, or the like. It may be implicit in terms of DCI format type received, for example, if the network signals a dynamic repetition indication in RRC. For example, based on RRC signaling and a received DCI type, the UE may know whether or not to use repetition based transmission or not. The UE may also be able to ascertain the number of repetitions based on context of the RRC and DCI combination, for example, a repetition factor may indicate this information. A repetition dropping configuration, in the event of a transmission conflict, may be signaled via RRC or other means.

Sub slot HARQ transmissions may include one or more PUCCH transmissions for indicating HARQ ACK feedback. In an embodiment, the PUCCH on each sub slot may be associated with a PDSCH or group of PDSCH. This may be performed based on an offset number of slots, subslots or mini-slots. The association may be a cross slot association, for example, a PUCCH of a next subslot or another subslot of another slot. HARQ ACK feedback may be transmitted for blocks of PDSCH when the PDSCH overlap each other partially or fully. There may be delayed HARQ ACK reporting when PDSCHs overlap only partially, such that the ACK is transmitted after both are fully received.

In an embodiment, repetitions (for example, 2, 3, 4, 5 etc. repetitions) of a data transmission may be scheduled by DCI or using other means. The DCI may indicate whether repetitions shall occur simultaneously, in series or interleaved among other repetitions. Some UEs may be capable of supporting no repetitions or may be configured to not repeat transmissions without being signaled as such. The UE may be capable of supporting an interlaced repetition pattern. Repetitions may be scheduled for example, consecutive or overlapping slots or odd/even slots, etc. As used herein, the term ‘repetition’ or ‘repetitions’ may refer to a repeated opportunity to transmit on a resource, slot, transmission time interval (TTI), transport block or may also refer to a set of any one or more of these items, for example a set of resources or a set of slots. A UE may receive a complete data segment after one or more repetitions but less than all repetitions. Repetitions may be reception or transmission receptions, i.e. downlink or uplink. Feedback for the repetitions may be received (or transmitted) at gap intervals from the last transmission or on a gap interval from each transmission. In one embodiment, the transmission may be concatenated with another signal. HARQ feedback may be transmitted one or more times during a TTI, slot, subframe or the like. A DCI may instruct a UE to transmit HARQ feedback on one or more PUCCHs in a same slot which may or may not depend on a numerology of the UE. Other DCIs may indicate grants for same slot or cross slot transmissions or receptions. Cross slot transmissions may begin on one slot, continue on the next slot and complete on a third or later slot. Cross slot transmissions may or may not use consecutive resource elements in time or frequency. Cross slot transmissions may be triggered dynamically and/or via configured grants.

A DCI or other trigger may indicate a resource allocation type for one or more repetitions. The resource allocation may indicate transmissions which occupy more resources in the frequency domain than time domain or vice versa. An allocation may be as an offset from a previous transmission or as an offset from one or more DCIs used to schedule one or more transmissions. One repetition type may comprise, for example, a resource for a first repetition may be explicitly provided and an offset from a previous repetition may be indicated for a next repetition. Offsets may also be used in the case of cross slot repetition scheduling. Another resource allocation type may comprise receiving a plurality of starting symbols (or starting positions indicated by a physical resource block or a portion of a resource block group) and plurality of durations for each transmission or transmission repetition. Another type of repetition may comprise a repetition pool, provided by RRC, shared among multiple UEs, wherein a plurality of potential repetition start times and durations are provided, wherein the UE may sense before transmitting. A DCI may indicate whether transmissions or repetitions may cross slot or other boundaries. A single duration field may indicate a total duration of the first transmission and any/all repetitions and/or whether the repetitions are configured for continuous or non-continuous transmission.

HARQ transmissions may be transmitted at an offset from one or more resource elements of any one of the resources used for the cross slot transmission. DCIs may indicate resources including HARQ resources (for example, a bitmap for first transmission, retransmission, etc), by a starting symbol and/or ending symbol or the like. Same may occur for multiple PUCCHs, i.e. the DCI may indicate which PUCCH corresponds to the DCI. HARQ transmissions may be timer based and/or may be explicit or implicit. The use of a particular timer may be reported as a capability. In one embodiment, the ability to transmit a HARQ-ACK on more than one PUCCH per slot may be reported by a UE in a capability report. The capability may be based on supported HARQ-ACK codebooks (for example, codebooks which support multiple ACK indication), numerology, subcarrier spacing or the like used for the transmission or feedback. For example, the UE may support simultaneous HARQ-ACK codebook generation based on a priority of the data to be transmitted. In another example, an ability to support cross carrier scheduling, in which the carriers are on different numerologies, may be supported. A UE may have a switching capability, for example, a time period in which the UE is capable of switching to receive/transmit on resources of a different TRP/numerology. When a UE is cross carrier scheduled, there may be a gap period or delay introduced depending on the numerology of the scheduled carrier or the carrier for transmission/reception. For example, the gNB may not schedule a UE on another carrier before the gap or delay period. For example, when scheduling resources on a carrier having a different SCS (higher or lower) than the carrier in which a DCI is received on, the UE may anticipate a longer or shorter delay than if the resources were scheduled on a same carrier. The gap period may be determined based on capability of the UE.

For ultra reliable communication, a different MCS or coding scheme may be negotiated and may be used for the HARQ-ACK transmission among other transmissions. HARQ-ACK transmission may be in accordance with the DCI format received, for example, for a given DCI, the UE may choose an associated HARQ-ACK codebook. Alternatively, or in combination, the UE may select a HARQ-ACK codebook based on an indicator in the DCI format or may not use a HARQ codebook at all. In an embodiment, a follow up DCI may be transmitted such that resources are provided for HARQ feedback, wherein the HARQ feedback is for resources of a previous DCI. Previous and follow up DCIs may include power parameters which may be applicable to a same transmission resource. Power parameters may include sets of power parameters each set directed to a particular transmission priority, i.e. for MTC, eMBB or URLLC traffic. Power levels and power level sets may be different for each transmission priority. Alternatively, HARQ may be multiplexed with HARQ from previous transmissions of another type, priority, or the like. For example, a HARQ ACK may be dropped in favor of a SR; a HARQ ACK may be transmitted over CSI or PUSCH or the like. HARQ for URLLC may always supersede eMBB or other traffic.

Multiple carriers and/or BWPs may have unique data channels but shared control channels. For example, a single DCI format may be received over a set of BWPs, yet schedule resources on only a single BWP. Alternatively, a DCI may occur on any BWP and yet may schedule resources on different BWPs or multiple BWPs. The same may be true in terms of channels or cells or even radio access technologies.

A scheduling request transmission sent from a UE to a base station (BS), for example a gNB, may involve transmission of a signal which begins at a first power or other level and then is incremented as needed. The UE may have an established power level that may be exceeded, on condition, for a scheduling request transmission. For example, the condition may be a capability of a UE. The condition may relate to a received signal quality indicator. The condition may relate to a carrier of the UE. For example, it may be more important to exceed the configured power level a primary carrier (or primary channel) as compared to a secondary carrier or other carrier. A UE may be configured with one or more primary channels and one or more secondary channels.

There may be a quality of service level configuration or transmission configuration that may be relied upon for determining power level conditions. The conditions may relate to a time (subframe, slot, etc), frequency (subcarrier spacing (SCS), BWP based) and may also be beam specific. SCS may be chosen as a subset, for example, based on applicability in terms of capability or support for a given transmission configuration. Further, the conditions may relate to whether the cell is a cell center UE, a cell edge UE and/or a location with respect to a TRP. A scheduling request or any other request for resources may include a channel estimation error or power control accuracy or inaccuracy measurement level. A scheduling request may be dropped if it overlaps with or collides with another PUCCH transmission of a UE, for example, HARQ feedback. In an embodiment, only a portion of an overlapping or colliding transmission may be dropped. If the scheduling request is for high priority traffic, the scheduling request may be transmitted while the PUCCH or conflicting PUSCH or any other conflicting signal is dropped. Additionally, if the scheduling request is a request for high priority traffic, for example, URLLC traffic of a high priority logical channel or logical channel group, even a data channel transmission or reception may be dropped to allow for the SR to be transmitted. The PUCCH may be a short or long PUCCH. The scheduling request may be transmitted on a condition the request is positive. Alternatively the scheduling request for high priority traffic may be multiplexed, for example, transmitted with another data.

A DCI may indicate multiple-TRP information in a multi-panel or multiple TRP use case. For example, the DCI may indicate a number of layers transmitted per panel and may also indicate a panel ID. Panel information including ID and the like can alternatively be signaled in RRC signaling.

In some embodiments, the PDSCH or other shared channels of each panel may be configured to completely overlap, partially overlap or not overlap at all. This fact may be signaled via DCI or signaled via another signal. Multiple DCI formats may be received with overlapping resources on a single BWP. In the case of a DCI format which schedules PDSCH or PUSCH on another base station or another carrier, the search space configuration may or may not be the same configuration as the cell which provided the DCI. If not, an indication of the search space configuration may be provided in the DCI. The search space used may inherently convey information of any one of the parameters disclosed herein. PDSCH may be scheduled in any number of symbols and may be preferably scheduled in 1, 2 or 3 symbols. In an embodiment, PDSCH may be scheduled in 4 to 14 symbols in duration. In another embodiment, PDSCH may be scheduled in more than 14 symbols in duration. Once a transmission exceeds a number of symbols, transmission parameters may be changed. Also, transmission parameters, for example, a frequency transmission may change once a slot or subframe boundary is reached regardless of a number of symbols transmitted. A transmission, for example, a retransmission may be dropped if it crosses the slot boundary. This may also be true if the next slot is a different direction, for example UL vs. DL or the opposite. The opportunity may be filled with smaller data of a high priority. Alternatively, once the symbol or slot duration is reached, and the UE determines that a next slot or symbol presents a conflict, the UE may postpone transmission or reception.

DCI formats sent by one TRP may schedule resources for another TRP. HARQ feedback may be provided to one or more TRPs, for example, the TRP which provided the DCI or the TRP for which an uplink/downlink transmission is scheduled on. PUCCH, PUSCH and random access channel (RACH) transmissions may be coscheduled in overlapping frequency/time/beam. PDCCH, PDSCH and other downlink channels may be coscheduled in overlapping frequency/time/beam. A gNB may indicate whether PDUs may be duplicated on the coscheduled transmission, for example, PDCP PDUs or whether unique data transmissions may be provided, for example, sequential PDCP PDUs.

Each TRP may have an associated PUCCH which may receive HARQ feedback for other TRPs. In one embodiment, a gNB may schedule an uplink or downlink transmission, for example, PUSCH or PDSCH, by a plurality of TRPs, wherein each transmission comprises a different redundancy version, yet having a same MCS. Instead of transmitting a plurality of DCI formats which comprise the same parameters, albeit different redundancy versions, a DCI may be transmitted which only includes necessary information for the uplink/downlink transmission to the TRP, for example by limiting a number of redundancy versions to 1, 2, or 4, in an example. This may be performed by limiting the number of bits of the RV indicated in the DCI, for example, to 0 or 1 bit from 2 bits in other formats. The RV may be selected using other information of the grant or other information disclosed herein. An ordering of transmissions or a transmission type separation per TRP may convey information about resource scheduling. Additionally, beam or beam subsets used by a TRP may convey information about resource scheduling in time or frequency.

A UE or gNB may detect a beam failure and a recovery procedure may be necessary. In one embodiment, beam recovery may be initiated by a timer. The same may be true for radio link failure. This would allow the UE to utilize a contention free period in which the UE may recover a beam. The UE may attempt to use preconfigured RACH resources to recover a beam. The subset of resources available for beam recovery may be greater than or less than the resources initially provided for initial or random access. In one embodiment, the beam recovery timer may be incremented upon successive failure attempts. In yet another beam recovery embodiment, upon beam failure, a UE may utilize a secondary cell or another cell, for example a WLAN cell, to signal to a PCell a request for resource(s) to perform a beam recovery procedure. The failed cell/beam may be indicated or conveyed to the base station. The resources may be signaled through the WLAN or other cell. During a beam failure, a UE may determine that it may need to perform random access to acquire a new timing advance and resource grant. The UE may then transmit on the resource grant. The UE may use the RACH to transmit information as to the cell (PCell, SCell) and an index or bitmap corresponding to the failed beams. The UE may also use higher layer signaling if possible, for example MAC signaling.

A DCI format may indicate transmission configuration information (TCI). This information may indicate that two or more base stations are providing PDSCH to the UE. In one embodiment, the UE may receive only one PDCCH from one of the two or more base stations. When a DCI format cancels a scheduled transmission, the DCI may be group specific. The cancellation DCI may be of few bits, for example, 1 or 2 bits, indicating one or the previous 1, 2, 3 or 4 received DCIs. The UE may monitor for the cancellation information when a TX of a given priority is scheduled. If a schedule TX is a highest priority, for example, URLLC, the UE may not monitor for a cancellation or preemption indication since there should be nothing of more urgent priority. Monitoring may be performed on a non-slot or mini-slot periodicity, based on capability and/or based on numerology/SCS.

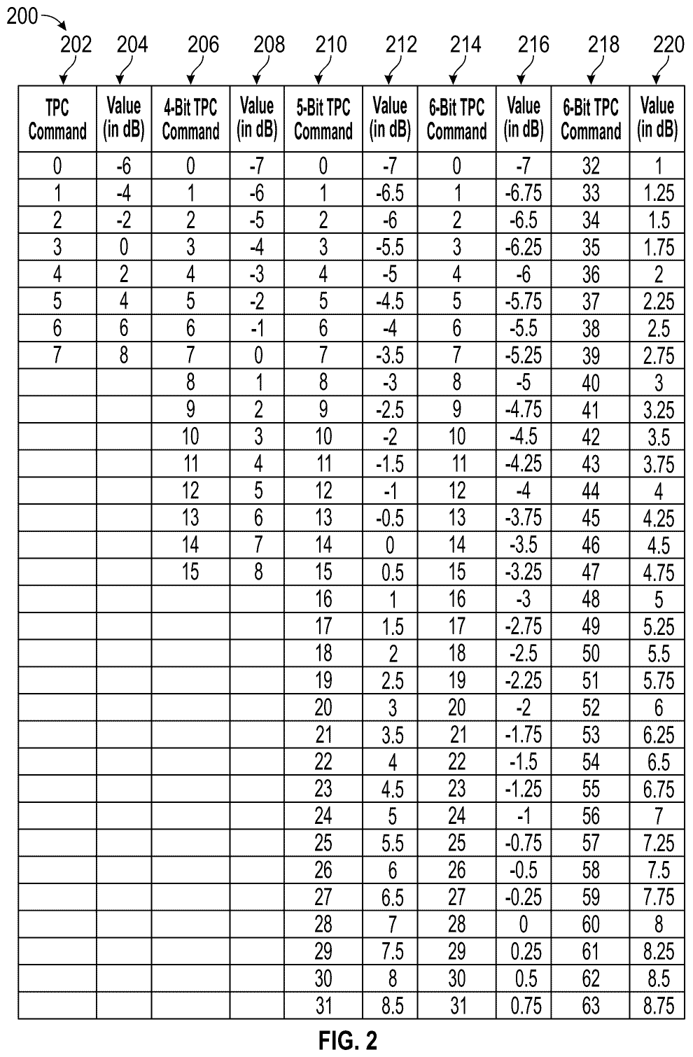

FIG. 2 is a table 200 which illustrates example TPC values. A new set of DCI format indicators may be used for indicating TPC values, for example, 30 may be used for a first TPC format with first parameters including those described herein, while 31 is used for a second TPC format with same or different parameters as disclosed herein. Formats 3_2 and 3_3, may be used for other formats, for example, for indicating up or down directions. These DCI formats may be used for non orthogonal MU scheduling or other scheduling as disclosed herein. Other DCI formats may include DCI format 4_0 which may be for signaling when a UE is in DRX active time or DCI format 4_1 for scheduling when a UE is not in DRX active time.

As shown in FIG. 2, a 3-bit TPC command 202 may indicate up to 8 discrete values 204 ranging from −6 db to 8 db. The values conveyed by each bit string may differ however in embodiments. A DCI format 42 may be used to indicate a 4 bit TPC command 206 having values 208 ranging from −7 db up to 8 db. Using additional bits may allow for additional granularity in adjustments. A DCI format 4_3 may indicate a 5-bit TPC command 210 with values 212 ranging from −7 db to 8.5 db on a 0.5 db range. A DCI format 4_4 may be used to indicate a 6-bit TPC command 214, 218 having values 216, 220 ranging from −7 db up to 8.75 db which increment on a 0.25 db scale. Any DCI format 4_x may signal any parameter or attribute disclosed herein. DCI formats may be used for time duplexed control/data transmissions or other transmissions. In one embodiment, DCI formats may provide a switching indication from FDD to TDD or vice versa. In one embodiment, DCI 3_x formats may be offset in time, frequency or beam from DCI formats 4_x and thus may not need an explicit DCI format indicator. Any DCI format disclosed herein may incorporate any scheduling parameter or other parameter as a component. Other DCI formats for scheduling of PUSCH may be 0_X formats, for example formats 0_2, 0_3 which may be used for PUSCH and other formats, for example, 0_4, 0_5, 0_6 may be dedicated or reserved for future uplink shared channel use, or the like.

Some DCI formats may be encoded such that the TPC value for scheduling uplink shared channel transmissions is consistent with or encoded with a repetition factor. This way, for a particular TPC value, a UE may also determine a repetition factor or number of transmissions/retransmissions. Preferably, as power is reduced via TPC, a number of retransmissions will also be reduced or remain the same. Similarly, as power is increased, a number of retransmissions will be increased. A UE may accumulate TPC values to form a transmit power level command. The UE may do this regardless of whether or not the UE out of order transmits the uplink transmissions. For example, if two TPC commands are provided prior to two PUSCH transmissions, both TPC commands may be accumulated before transmitting either PUSCH. The UE may alternatively delay the second TPC command until after transmitting the first PUSCH regardless of priority or out of order nature of the transmissions.

Preferably, format 0_2 will be used for scheduling URLLC PUSCH and a format 1_2 with be used for scheduling URLLC PDSCH. In a preferred embodiment, elements of the format 0_2 will be variable size, for example, including 0 bits. These variable size elements may include carrier indicator which may be used only when another carrier is being scheduled for PUSCH; PRB bundling size; rate matching indication; and a CSI-RS trigger indication. CSI-RS may be triggered with or without a data payload and may be associated with a SCell or another cell of the UE. A MCS may or may not be included in a DCI format 0_2. The same may be true for a redundancy version and new data indicator and an indication of these elements may be provided by RRC signaling. A CBG transmission information may be included in legacy DCI formats, but may or may not be included in a format 0_2. Format 1_2 may include elements similar to 0_2 and may or may not include any one of the elements disclosed herein.

These DCI formats may include or indicate any one of the parameters herein. For Scheduling PDSCH, or other data, DCI formats may be denoted as 12 which may be a dedicated DCI format for URLLC. Other Low latency DCI formats may be reserved for future URLLC use, including format 1_3, 1_4. In a preferred embodiment, PDSCH will be scheduled using a format 1_2. These DCI formats may indicate resources for any information, information type or information format disclosed herein. PDSCH may also carry scheduling information, for example, an indication of a group for uplink HARQ ACK feedback or other feedback information (SRS, CSI, etc). That is to say, multiple PDSCH receptions may group feedback together and transmit as a group. DCI formats may include a header and payload portion so as to indicate information about the following payload portion. The header may be on a first portion of time resources and may indicate the DCI format which may include 1 or more bits for this purpose. Using 1 bit may signify whether resources are scheduled for UL/DL. In an embodiment, any DCI format disclosed herein may have a total number of bits which is fewer, equal to or greater than a DCI format 00 or DCI format 0_1, 1_0, 1_1 etc of R15. DCI formats which use less bits may or may not take priority over time conflicting DCI formats with larger numbers of bits.

These legacy DCI formats may also be modified to include any one of the parameters, for example, disclosed herein. The UE may monitor the PDCCH using an aggregation level 8, aggregation level 12, aggregation level 16 or any other aggregation level, for receiving DCI information disclosed herein. Depending on the aggregation level, different DCI formats or parameters may be used. For example, for one aggregation level, a MCS subset may be selected or used. Aggregation levels may be identified by DMRS. Some DCI formats, such as 0_0A, 0_0B, 0_1A, 01B may provide extensions to 00 and 01 for scheduling PUSCH, based on aggregation levels. Similarly, DCI formats such as 1_0A, 1_0B, 1_1A or 11B may provide extensions to 1_0 and 1_1 for scheduling PDSCH. For group transmissions, or TPC transmissions etc, extensions to DCI formats, for example, an extended format 2_0A, 2_0B, 2_1A, 2_1B, 2_2A, 2_2B, 2_3A or 2_3B. In an embodiment, a UE may be provided with an index into a table or bitmap which indicates a resource for use in a time or frequency manner. The same table or bitmap may indicate a MCS or beam (via the index specified via DCI). The table or bitmap (indicating symbols, slots, transport blocks or the like) may be scheduled in advance via MAC, RRC etc or may be included in a DCI. In one embodiment, the table may be via a SIB. A DCI may indicate implicitly, as an offset of the DCI itself or any parameter included within, another scheduling parameter, be that time/frequency/resource/beam or the like. For example, RRC may schedule groups of resources which can or cannot be used for URLLC and a DCI may indicate one or more of the groups.

In one example, a first DCI format may indicate a parameter used for resources scheduled by a following DCI format. For example, a first DCI format, for example DCI format 5_0, 5_1, 5_2, 5_3, 5_4 or the like, may indicate resources for receiving a second DCI format which follows subsequently. Alternatively, these formats may simply indicate resources for, or parameters of, the disclosure herein. A first DCI format may have a boolean indicator to indicate whether the first DCI is scheduling a subsequent DCI format. The first DCI may indicate carrier or TRP of a same (for example, quasi co located) or another base station. Parameters may include MCS, power, HARQ parameters (for example HARQ group parameters), or any other parameters as disclosed herein. MCS may be selectable between 0, 1, 2, 3, 4 or 5 bits. The DCI may indicate the number of bits used. The following DCI format may include only parameters which are different from or have changed since the last DCI transmission for the same format. Power parameters for some attributes or parameters may be provided or indicated as an offset from another signal or parameter disclosed herein. For example, an offset of 1 dB, 2 dB, 3 dB . . . 7 dB, 8 dB etc. If a transmitter cannot transmit at full power, for a given rank, precoders of a codebook subset may be used for one or more transmissions or retransmissions.

Any one of the DCI formats herein may provide parameters for use for uplink or downlink control or data information, for example, for an uplink DMRS transmission. The UE may receive, via DCI, a scrambling identity for DMRS and a code division multiplexing (CDM) group index.

In some embodiments, DCI may be two step or multiple step. In a step, a base station may indicate which DCI formats are supported/allowed. A DCI applicable to existing DCI formats, for example, those disclosed in 3GPP TS 38.211 V15.3.0 (2018-09), disclosed herein in entirety, may be received first. That DCI may be followed by another DCI format. Other parameters may be specified in terms of bit length, for example single bit flags or multiple bit parameters. Other parameters disclosed herein may be summed or multiplied as indicated by a DCI. DCI may specify a transmission type, a modulation scheme, resources used for transmission (time domain, frequency domain) or the like. A time domain indicator may be anywhere from 1-8 bits depending on number of time domain resources. A DCI message or other message may indicate preemption, wherein a previous opportunity for transmission or reception is preempted by a higher format transmission or reception. The indication may be provided in terms of the resource preempted or a QoS indicator or other means. Power or QoS may be reflective in nature, i.e. may be similar or identical to a received power/QoS. DCI format may indicate a power, log, floor, and exponent or ceil any resource format, type or time/frequency indication as specified herein. A DCI message may provide information about a numerology or bandwidth part information of another carrier, for example. If there is not enough time to decode the reception on the another carrier, the UE may determine to drop the reception.

A DCI may indicate resources for multiple frames or subframes in a same DCI. The DCI may also indicate a semi-persistent allocation or the like. Another DCI may override or discontinue the allocation. A DCI may be scrambled using and parameter or mechanism disclosed herein. For example, DCI formats may be scrambled by a non-orthogonal multiple access (NOMA) group identity, another group identity, a cell identity, a random access identity, a system information identity, or any combination of the preceding identities.

A sidelink control information (SCI) format may include an indication of resources for sidelink transmission, modulation and coding scheme information, UE identifiers, UE group identifiers, capabilities of one or more UEs, sensing parameters/configurations or any other information or parameter disclosed herein. There may be multiple different types of sidelink control information provided, for example an SCI format 0, SCI format 1, SCI format 2, SCI format 3 or the like. Some SCI formats may be provided to single UEs, while others are broadcast, group based or subgroup based.

A DCI format may include, or may be selected based on: a number of antennas (or number of antenna radiating elements) at the UE or base station, a number of users in a cell or in an area, a number of resource elements, a spreading length; decoding information; a Boolean indicator to signal hard or soft interference cancellation; matrix column and row information; number of bits used for coding; number of users per RB; a number of antenna ports; band; bandwidth; radio access technology; a transmission configuration indication or the like. Any of these parameters may be for a subsequent downlink transmission or uplink reception (by the base station). Other DCI formats may indicate a modulator mapping, bit interleaving (for example, user or group specific) parameters, spreading parameters, scrambling parameters, timing assignment, power assignment, a resource element mapping or the like. The timing assignment and power assignment may be provided via an index. For scrambling or spreading, the UE may be provided with a random number of an index or seed for plug into a random number generator. The seed may be an initialization seed and may be received via DCI. DCI formats may provide spreading or superposition parameters. DCI formats may indicate resource elements for 0 transmission levels. In one embodiment, the RE's for 0 transmissions may be indicated via a pattern or bitmap. Alternatively, they may be indicated implicitly based on other DCI parameters. For example, based on bandwidth, band, radio access technology (RAT), number of users, or any other parameter disclosed herein. Any hash for security purposes may include the 0 transmission values or drop any 0 transmission values from the hash calculation. The DCI format may indicate hash function to be applied. DCI parameters may be implicit based on the hashed capability of the UE. For example, MCS or HARQ timing may be implicit based on capability exchange.

DCIs may be received with conflicting resource scheduling parameters. For example, a first DCI may indicate downlink reception on a plurality of resources. A second DCI may be received indicating downlink reception on a subset of the same resources. Conflicts may be resolved by a priority indicator or a timing indicator. If a DCI has a higher priority, the UE may perform actions of the highest priority DCI. Otherwise, the UE may pick a first or last DCI to perform. The UE may also compromise by receiving a portion of both (or transmitting on a portion of both). As for transmitting, the overlap may not necessarily be on a same resource but may cause a power level to be exceeded. In this case the same rules may apply, a first/last or priority may take precedence. A traffic type may be indicative of priority. The UE may also consider whether resources indicated by a DCI have commenced transmission or reception. If this is the case, the UE may ignore the later received DCI. Alternatively, the UE may stop reception on first resources if the priority of the second DCI indicates a higher priority by a given level. Grants may be dynamic and a dynamic grant may take precedence over a non-dynamic grant or vice versa.

DCIs may be provided on a control resource set (CORESET) of a bandwidth part (BWP) of a whole channel bandwidth (CBW). The CORESET or CORESET length may indicate a type of DCI provided to the WTRU. The type of PUSCH or PDSCH may indicate type of DCI. A CORESET may be transmitted on one or more symbols. DCIs or other information provided to the UE may enable the UE to switch BWP to an initial BWP or another BWP, for example, an express indication to switch, an indication to start an inactivity timer or the like.

Other DCI formats may be cross bandwidth part, i.e. may schedule resources on another BWP or even another CBW of another radio access technology. This type of scheduling may be done in combination with RRC scheduling parameters. For example, the RRC may schedule blocks or pools for which DCI specifies or indicates resources of. In this way, PDCCH and PDSCH may be simultaneous in time. A UE may autonomously switch BWP based on traffic parameters including arrival rate/burstiness, QoS parameters, position, transmit power, a timer or the like. A BWP may be selected based on these parameters or information elements as well as on an expected traffic type or file size.

A UE may be provided with an uplink grant that the gNB or other base station must cancel, defer or reschedule, which also may be done by a DCI format which may be group common or UE specific. This may be due to the gNB recognizing that the scheduled or granted uplink resource should be reassigned for a higher priority transmission of the same or another UE. Thus, a UE may be provided with the resource due to the higher priority. The lower priority transmission which was subsequently cancelled may be cancelled via DCI, MAC CE or other means. The DCI may indicate a frequency, time and/or beam of the resources to be cancelled using a same number of CCEs as the original DCI scheduling the resources. The original transmission may be resumed subsequently or dropped altogether based on a remaining portion or a priority thereof. The resumed portion may be multiplexed or transmitted after receiving a following DCI indicating a transmission priority of a same or another priority of the original transmission. The UE may determine to cancel the transmission due to determining a higher priority packet in the buffer. In one embodiment, another gNB may provide the cancellation instruction to the initial UE. Instead of cancelling, the UE may be provided with an indication to lower transmit power or may be provided with alternative resources for transmission. The receiving gNB may then perform interference cancellation and receive both transmissions. In one embodiment, the grants may be provided to multiple UEs and subsequently cancelled in a group fashion. It may be that only UEs in a certain location, having a certain access type, being of a certain category or scheduled with certain frequency or time resources may be instructed to cancel while other group members maintain their transmissions. A UE may be capable of cancelling a transmission in a given time X, Y or Z and this capability may be reported.

The DCI or other information used to cancel transmissions may include a carrier indicator or RAT indicator to indicate a transmission or transmission frequency. The DCI may include a transmission priority for which the UE should cancel transmission to that priority level.

The UE may be provided with system information, for example, SIB information, directly from the transmitted random access request. Alternatively, the UE may be provided with an indication of resources for use for transmitting a request for the particular system information desired. In response, the UE may receive a MIB, SIB, or partial SIB, etc. Because the UE is not in connected mode, the UE may need to be preconfigured with access and timing information for performing the PRACH transmission in advance. It may be that a certain portion of the preconfigured resources are dedicated for SIB type random access requests. This way, there may not be a need for a specific request after the random access request. In response, the base station may respond on preconfigured resources. In connected mode, the UE may provide mobility state information, for example, information regarding whether the UE is stationary, mobile or fast moving. This may aid in power control as the UE may not be necessarily scheduled to report channel quality as frequently when not moving or may report more often as it becomes more mobile. The UE may receive a configuration for reporting channel quality and/or measurement taking which is based on the mobility state. Channel quality reporting may occur more frequently when there are more users using an MU transmission medium vs less users using a MU transmission medium. In an embodiment, channel quality reports may be included in RACH transmissions and subsequently in PUCCH transmissions.

Because meters communicate infrequently, it is important that only minimal bandwidth be allocated to them. Meters may be allowed to sleep until woken up. In some cases, a meter or other device may be instructed to sleep or enter a power save mode in a DCI format or other communication. The DCI may also include wake up scheduling parameters, for example, a temporal key for use upon wake up, and what to do upon wake up. A meter may or may not wake up depending on whether it has enough energy to wake up and make at least one transmission. The determination may be made based on a battery level which may be charged via light (similar to a photovoltaic solar cell solar such as one found in a calculator; a water meter may be powered by water pressure, or the like). A UE may be powered wirelessly while simultaneously receiving data. The actual charging mechanism may be application specific. The wake up signal may be tailored to this application specific charging mechanism, for example, a wireless charging mechanism. In some embodiments, more than one meter may be woken up using a same wake up signal. The wake up signal may be addressed to multiple meters (or multiple groups of meters) and may also poll the meters for simultaneous or sequential communication. In the case of simultaneous communication, a beam forming technique may be used to avoid collision. A wake up signal may convey one or more UE IDs, a group ID, one or more cell IDs representing the transmitter of the wake up signal, and the resources for transmission of any buffered data (for example, buffered group data, buffered single tx data) of the meter. Instead of an entire UE ID, a number of least significant bits may be used to convey UE ID or Cell ID etc. Cell id may refer to a unique id of a cell in a global sense or within a single mobile network or carrier network. A wake up signal may convey IP address (static, dynamic). A wake up signal may also have a wake up RNTI and may synchronize the MTC device with a cell or provide synchronization information for another cell or carrier. The wake up signal may indicate a switch of a bandwidth part. In some instances, multiple meters may be triggered for a response occurring in a single subframe (e.g. a plurality of responses are transmitted in a same subframe. A wake up signal may be monitored for in one or more resource elements, for example, in a plurality of resource elements which make up a DCI format. If no response is received, the wake up signal transmitter may retransmit the wake up signal using a different band, different ID (group ID or individual ID). A wake up signal may span x subcarriers, for example, 10, 11, 12, 13, 14 or 15 subcarriers which may have a subcarrier spacing of 312.5 KHz. If the number of subcarriers is less than a number x, for example, less than 13, a number y=13−x subcarriers may be used to convey additional information to the STA aside from the wake up signal. A long wake up signal and a shorter version may be transmitted by a same TRP, gNB, STA, UE etc. The shorter (or longer) version may be supported by some stations yet not others.

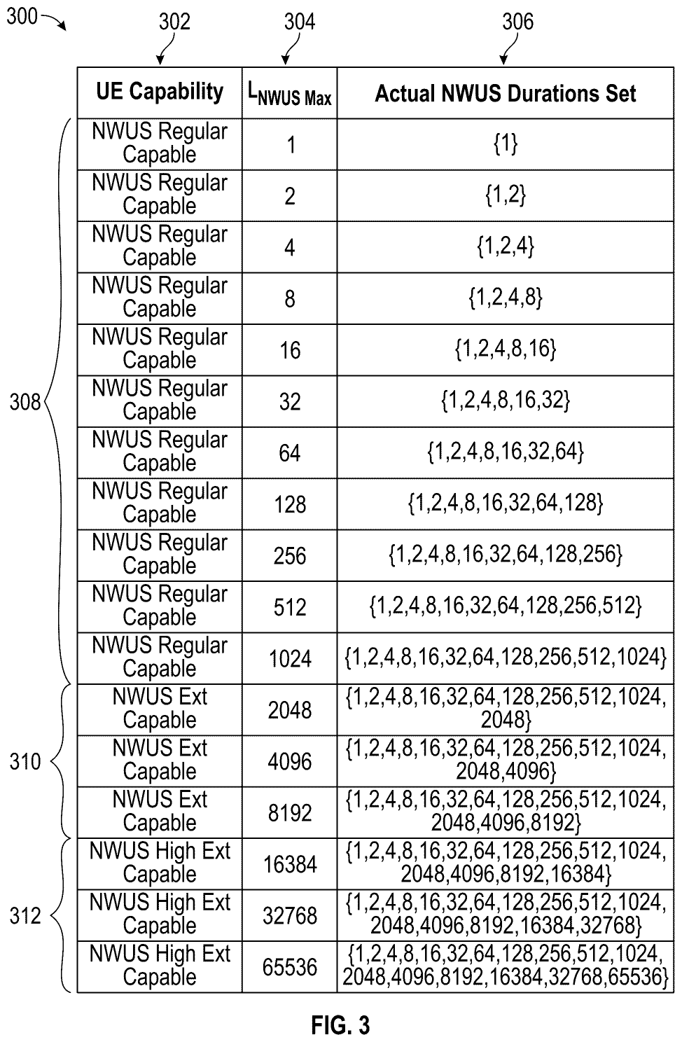

FIG. 3 is a table 300 which illustrates an example of such wake up signal duration settings. A UE or may report a wake up signal capability to a network or base station to indicate a capability to receive wake up signals and respective length times. In the example shown in FIG. 3, a UE may have a capability 302 indicated as a regular NWUS capable UE 308, as a NWUS high extension capable UE 310 or a NWUS high extended capable UE 312. According to an NWUS max value 304, a set of supported durations 306 may be configured. The UE may be capably of indicate length times as a command or signal length, i.e. a length of time for which the wake up message is received in. For example, a device may be capable of a long wake up signal and a short wake up signal. The shorter signal may only indicate a portion of a UE address, for example a portion of a MAC address, AID or the like. The capability may include a capability of receiving a may be a factor of wake up signal duration or a factor of

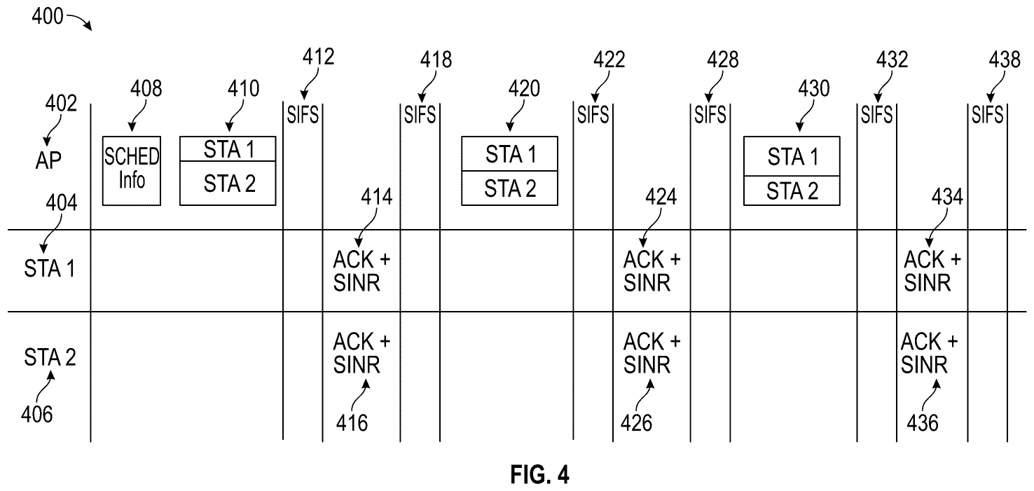

FIG. 4 illustrates a method 400 for determining a transmit power level for NOMA communications among STAs and APs. In on embodiment, an AP 402 may send scheduling information 408, including a duration and power level parameters, to STA1 404 and STA2 406. The AP 402 may then proceed with a cascading power level transmission method. The method may chose at random a first STA to transmit a signal with high transmit power, for example, STA2 406 has high power in an initial transmission 410. Both STAs may simultaneously or sequentially respond 414, 416, after a SIFS 412, with an acknowledgement and SINR or other indication of signal quality. Next, the AP 402, may transmit to STA1 404 and STA2 406 using an equal power level 420 for both STAs after another SIFS 418. After another SIFS 422, STA1 404 and STA2 406 may transmit an ACK and SINR 424, 426. After a SIFS 428, the AP, may allocate high power to STA1 404 and low power to STA2 406 in a transmission 430. After another SIFS 432, the AP 402 may receive another ACK+SINR 434, 436. The AP 402 may determine, from the ACK and SINR signals received, a preferred power for each receiver for transmission of NOMA type multiplexing. Using groups IDs, STAs may be targeted as a group or groups. Each one of the transmissions may employ 802.11 format type messages with SIG fields, MAC fields, or the like. Any one of the parameters or signals herein may be included in these SIG or MAC fields. A counter may be transmitted with each cascading transmission by the AP.

Ranging based determining transmissions may be cascaded similarly to FIG. 4. For example, a STA or AP may send a ranging NDP announcement frame subsequent to a ranging poll frame. The NDP announcement may have a plurality of STA info fields configured. The STA info fields may include an AID and a token field matching a token field of the ranging poll frame.

A wake up signal may be defined and employed such that a period of time or gap may be employed before a paging occasion occurs. As such, the gap may be configured for the meters to share data. The paging occasion delay may also be variable based on a number of MTC devices which actually have to transmit. Paging may indicate resources for reception or transmission of data. Alternatively, paging may also be used to simply transmit a short message to an MTC device or UE without any resource indication. A combination of the two may be employed. In one embodiment, a legacy DCI format may be tweaked to indicate whether or not some bits are used to convey actual paging data. A paging message, for example a wake up page, may be an unacknowledged message. Alternatively, paging may be ACKed by some devices. A reference signal, for example, a narrowband reference signal may be sent on a non-anchor for paging purposes. A paging identifier may be conveyed by a wake up signal. Paging messages may be sent on one or more beams, for example, one beam, a subset of beams or all beams of a gNB.

A UE may refer to a cell phone, portable electronic device, PDA or the like. Lesser known UE implementations may refer to biometric devices or sensors which are deployed either in body, on body or near a human (or other animal) body. These UEs may aid individuals with disabilities or illnesses which require monitoring and control or aid. These types of UEs may utilize spectrum in the ISM band or another band, for example, the MICS band which refers to the Medical Device Radiocommunications Service. These UEs may communicate with devices which utilize spectrum outside of the ISM band, for example LTE or NR spectrum. Implanted devices may employ a battery which may be charged via a wireless or wired connection. A coil may be used to wirelessly charge a battery. Sensors may include window sensors, gas sensors (i.e. auto gas sensors, in home gas sensors, landfill gas sensors, or the like.) Sensors may be employed in windmills (wind speed, propeller speed) to sense characteristics and report those characteristics wirelessly. Other remote devices include billboards. Devices may be configured to report information over a power line connection to another device which is configured to transmit the information wirelessly. For example, a meter may be employed for the wireless transmission of information reported over power line communications. A UE may report a capability to be charged wirelessly, for example, at a particular distance away or via a particular beam configuration. A beam configuration may include or support beam correspondence.

In some embodiments, a UE may be configured to operate in a multiple radio access (MR) dual connectivity (DC) (MR-DC) state or spectrum. In one scenario, the MR-DC spectrum may incorporate bands of LTE, NR, ISM, Bluetooth, 802 or the like. It may be that the UE operates in spectrum which is continuous within the same band, or the UE may operate in spectrum which is not continuous within spectrum of one connectivity link of the dual connectivity state. In one embodiment, a UE may be configured with a maximum transmission power which is equal to a sum of the power used for two or more of the frequency bands, for example, power of LTE+power ISM must be less than or equal to a max power (for example, 23 dBm or 46 dBm). Each one of the LTE, NR, ISM, Bluetooth, 802 type bands may be considered when reporting capability of maximum transmit power. In one embodiment, power may be scaled according to a UE class or type. The supported type of dual connectivity may be indicated to a base station or other device. The UE may report a power level capability as a power profile. Power profiles may be configured in terms of one or more preferred power levels or configurations. A preferred scheduling, for example, cross slot vs. same slot scheduling may be reported and the network may select a scheduling method via DCI, MAC or other methods including a wake up signal.

For example, some DCI formats may indicate frequency hopping parameters for the UE to utilize. The UE may need to transmit data which is frequency hopped in a slot or across spectrum, for example using multiple mini slots, for example via repetition, for transmission. DCI may also provide SPS parameters for use with frequency hopped transmissions. One or more DCI formats may provide resources for UL transmission, DL reception, UL sidelink/v2x or DL sidelink. These resources may be transport block size denoted, in accordance with a transmission, retransmission, second retransmission or the like. Some elements of a DCI may be variable in size. For example, a number of UE IDs may be indicated. The number of elements or length of the variable field may be provided. In another example, any one of the parameters or attributes disclosed herein may be included in a DCI format, yet when the DCI is transmitted, a UE may transmit some fields with a lower than maximum number of bits. In some examples, the number of bits may be 0. In one embodiment a DCI format may combine one or more of UL transmission, DL reception, UL sidelink/v2x or DL sidelink/v2x such that resources for UL and DL are assigned together or that UL transmission and DL sidelink/v2x resources are assigned simultaneously in one DCI. For example, an uplink and/or downlink assignment index may be provided.

DCI formats may be based on UE capability. In some settings, v2x resources may be configured by a base station. These resources may be used for a first UE to communicate with a second UE and may change or be switched from transmission to transmission. Resource configurations may vary over time and each configuration may have an associated DMRS or associated uplink control information. The resources from the base station may be indicated over a first radio access network, while the transmission from UE to UE may occur over a different radio access network. One may be NR, one may be LTE, one may be WLAN or any other technology. In one embodiment, a WLAN frame may be modified by including any one of the parameters disclosed herein into a PLCP preamble, for example, into a SIG-A or SIG-B field of the PLCP preamble. The modified frame may be transmitted or received.

A base station may indicate capabilities, and may determine appropriate transmission characteristics, according to UE identifier to one or more devices for v2x/sidelink communication. For sidelink communication, a UE may be configured to communicate via groupcast transmissions. In one embodiment, the UE may be configured to use a lowest capability of any member of the group for a transmission. Sidelink transmissions may be transmitted according to one of OFDM or NOMA based on the capability information.

A frequency hopping scheme may be employed for random access. In some radio technologies, bandwidth may be determined by a threshold bandwidth, for example, 30, 40 or 45, 60 khz and a multiplier. So, the threshold multiplied by an integer or non integer, such as a decimal number, may indicate total bandwidth. In case of detected collision (or overlap) of a random access with another transmission, a RACH transmission may be delayed or postponed. Delay or postponement may occur via a timer or other indicator. In an example, each time a RACH is unsuccessful, on a particular beam, carrier or in accordance with any other parameter disclosed herein, a counter may increment and a following transmission may be optimized or performed differently. For example, preamble transmission counter may be incremented and/or another counter may be incremented to determine radio link failure or another radio link issue.

A delay of RACH or another high priority transmission may not occur regardless of whether the UE is configured with a measurement gap. If a decimal is set to a value less than 1, then a narrowband may be defined. In narrowband frequency hopping, RACH transmissions may occur with a varying scheme. For example, if transmissions occurred at a set distance in frequency, collisions may be frequent as many UEs may have the same pattern. A random hopping approach could be used to avoid this deficiency. In one embodiment, a bandwidth size may be used to determine a bandwidth hopping gap size. In an embodiment, a gap size may be set to a bandwidth size divided by an integer number. For example, in one embodiment, a 30 khz bandwidth divided by 20, provides a minimum gap size of 1.5 khz. A UE could hop a minimum of 1.5 khz (and maximum up to the determined bandwidth). Or, it could hop a random number between the two. For example, if a random integer number (rand_int) is generated between 1 and 20, the UE could hop rand_int gaps. If the hop gap exceeds the bandwidth, the hop value may simply wrap around to the lower bandwidth. A delay may be provided after a set period or set number or hops.

Frequency hopping may apply for any transmission disclosed herein regardless of whether the transmission is in the uplink, downlink or sidelink. The same is true for redundant data receptions, i.e. the transmitter may transmit a same signal, for example, a same PDU twice. Same signal may be changed somewhat, i.e. modulated differently or coded differently but may be a same transport block etc. In an embodiment, different numbers of resource elements may be used for each redundancy version. For example, a first transmission may have control+data Res, a second transmission may have just control Res and a third may have just data Res. There may be more (or less) data REs for subsequent transmissions and the UE or TRP may fix this up via a circular buffer or other means.

In some embodiments, a UE may have redundant circuitry. In fact, some UEs may implement dual cellular stack and dual hardware. This is so that each stack may be used to connect with a different base station and provide redundant (same time) access. This may improve throughput, reliability and latency. A gNB may report statistics, for example via broadcasting, as to the percentage of UEs which satisfy particular throughput, reliability and latency standards/requirements/thresholds.

To aid in reception of a signal, a transmitter may include a known reference signal or signals called demodulation reference signals (DM-RS). In one embodiment, the DM-RS may be code division multiplexed. There may be different CDM groups.

A UE may be configured with one or more bandwidth parts (BWPs). Each BWP may have an identifier which unambiguously identifies the bandwidth part. BWPs may be configured sequentially or non-sequentially (i.e. with gaps or other non sequence). Sequentially may be initially starting with 0 or 1, then 1, 2, 3, etc. A reverse sequence may also apply so as to convey a highest identifier first which may allow a UE to identify quickly a highest number of BWPs. A UE may only transmit on one BWP at a time or may transmit/receive on a supplementary BWP. In one embodiment, BWPs may be configured via a base station to coincide in frequency such that they are in bands next to each other. Alternatively, BWPs may be configured for in bands which are not next to each other, i.e. other bands span between them. In one embodiment, BWPs may be configured such that they do not overlap with bands of another radio technology, for example, 802 or Bluetooth. This way, the UE could simultaneously transmit or receive using the alternative technology while also transmitting or receiving in the 2 (or more) BWPs to the base station. The UE should monitor total power output for the 2 (or more BWPs) and the alternative frequency transmissions so as to ensure that a maximum power level is not reached. A UE may receive a broadcast signal or other signal which indicates that all or a group of UEs should move to one BWP. BWP signaling may be done on a . . . −2, −1, +1, +2 . . . basis. For example, a base station may signal a BWP which is 2 or 1 BWP(s) lower than that the UE is already using. Or it could be the opposite direction.

BWPs may be configured and/or activated. The UE may determine which BWP of the plurality of BWPs to transmit or receive on. The UE may chose 1 or more BWPs. BWPs may be activated or configured in accordance with a reference signal provided by a gNB. A UE may report a preferred BWP which may determined via application specific parameters. Applications may include video, audio, gaming, virtual reality etc applications. Parameters may be based on QoS or QoE.

Sequence numbers may be used by a UE for ordering of Packet Data Convergence Protocol (PDCP) protocol data units which may be transmitted or received by a UE. A UE may support and may indicate support for PDCP sequence numbers of varying sizes. For example, a UE with a particular capability may support 15 bit capability in a first mode, yet support an 18 bit capability in a second mode. In another mode, 16, 17, 18, 19, 20, 21, 22, 23, 24, 25, 26, 27, 28, 29, 30, 31 or 32 bit PDCP sequence numbers may be supported. Sequence numbers may be included in broadcast, multicast or unicast frames.

PDCP sequence number sizing may be based on access technology. For each one of the access schemes disclosed herein, a different PDCP sequence number size may be used. In one embodiment, PDCP sequence numbers may be validated based on PDCP PDUs received from one or more network paths. In one embodiment, if a base station or UE detects that radio conditions are degraded in a dual connectivity scenario, the base station or UE may switch to a duplicative PDCP transmission method, if a plurality of paths are available, in which PDCP PDUs with a same sequence number are transmitted in parallel (in one embodiment, on different frequencies or using different radio access technologies). In one embodiment, the PDCP duplication method may be on a PCell/SCell, two different TRPs or provided to two different gNB, or on licensed vs. unlicensed bands. PDCP duplication may be initiated based on QoS, link quality, application layer priority, an availability of multiple cells or the like. An entire PDCP may not necessarily be completely duplicated, rather only a portion of the PDCP PDU, for example the header portion, may be transmitted in duplicate. A gNB may instruct a UE to duplicate or not duplicate, for example, a UE may not duplicate and may soft combine the received PDUs at a PDCP or lower layer, for example a PHY or MAC layer. Alternatively, or in combination, duplication may be performed based on a number of NACKs received or a timer.

A UE in dual connectivity may have a master cell group and secondary cell group which share or do not share resources. A dual connectivity or a handover (using either make before break or hard handover) scenario may require the UE to instantiate two distinct network stacks, for example, two or more MAC layers, two or more RLC layers, 2 or more PDCP layers etc. A UE may report a number of RLC layers as a capability. A UE may indicate which RLC layer or which PDCP layer will be used for a transmission. A TRP may do the same. In a dual connectivity scenario, if the UE has one redundant PDU session with one or more TRPs and a power level is determined to be exceeded, instead of dropping or discontinuing the dual connectivity connection, the UE may switch to a single PDU session while maintaining dual connectivity, i.e. one or the redundant sessions may be torn down.

In vehicle applications a meter may monitor a battery or other electronics of a vehicle. A meter may be used to monitor current or voltage. The meter may also monitor capacity of battery cells. The batter or battery cells may be series-connected battery elements coupled to the meter or a wireless data acquisition system. A measurement may be taken during an operational period of the battery or during vehicle idle state. While in operation, the vehicle may be found to have an exceptional characteristic pattern or may throw a hardware or software based exception. Vehicles may indicate capabilities to a network including engine capabilities, communication capabilities, operator information, terrain conditions, tire conditions, oil and gas information or any potential overheating condition capabilities. Vehicle meters may monitor road condition and road condition management systems. Road condition management systems may identify traffic patterns and environmental conditions. Problems may be potholes, debris, construction work, abandoned or displaced vehicles or other issues. The meters may compare the vehicle to other vehicles trajectory, speed or movement. Meters may control or monitor an accelerometer or foot pedal of a car, any cameras or sensors, devices that are in or on the road like magnetic or wireless transducers, tire pressure or condition, a Doppler radar, rain temperature or police activity. Vehicle sensors may monitor for water, ice, snow or visibility conditions. Vehicles which are grouped closely together and share the same characteristics may receive group messaging indications or data from an AS based on sensor readings or information provided. Vehicle sensors may monitor Doppler frequency and report same on a periodic or aperiodic basis.

Doppler may affect transmission/reception. During synchronization, a UE needs to detect synchronization signals, for example PSS and SSS or an unlicensed band synchronization signal or unlicensed band reference signal. These signals allow for synchronization and determination, by the UE, of an identifier of a transmitter (e.g. base transmission reception point) or even mobile TRP. In the case of a mobile TRP, for example one mounted on a car, truck, train, blimp, aircraft, etc., Doppler shift may be relative to the displacement of the TRP from the UE. This may be even worse depending on the carrier frequency. Therefore, Doppler shift may be determined and compensated for. A MIMO compliant UE might use multiple beams to search for the TRP, each beam tailored to a slightly different frequency. A best case could be an ideal frequency all the way up to a threshold for a worse Doppler shift quantity. In this way, regardless of the Doppler shift, a UE may detect a TRP transmission in one (or more) time periods. Alternatively, Doppler shift may be determined based on information received from another cell (or based on a transmission of another cell).

Synchronization may be provided by another signal other than the PSS and SSS. For example, a resynchronization signal may be useful for UEs which have synchronized with a cell in the past. A resynchronization signal may be detectable once a UE has already received PBCH and one or more SIBs. Periodicity, length, coding or other parameters may be provided via the one or more SIBs (for example, SIB10, SIB11, SIB12, SIB13, SIB14, SIB15 or the like). Signals, for example, resynchronization signals or reference signals may be coded by Zadoff Chu, Gold code, Hadamard code, a pseudo random sequence, for example, pseudo random binary sequence (PRBS) or the like. The PSS and SSS may be coded in a similar fashion. Resynchronization signal may occur before PSS, after PSS or after SSS (or in any other combination or fashion). A single secondary synchronization signal may convey both physical cell identification and the timing information needed for synchronization. A resynchronization signal may occupy less than an entire physical resource block, a PRB or multiple PRBs. To covey a resynchronization signal using limited bandwidth, the signal may not have to convey an entire physical cell identification. It may convey only a portion of the bits dedicated to PSS/SSS, enough for a UE who already accessed the cell to determine with reasonable probability that the cell is in fact the cell the UE desires to connect with. The resynchronization signal may be transmitted on another band as the primary SS and secondary SS. This band may be licensed or unlicensed and may or may not contain beacon or other coexistence signaling (power level bitmaps, power control signaling or the like). Reducing the number of bits dedicated to fully identifying the physical cell ID may free up bits for conveying other information. Some information may be, for example, whether important information of the cell has changed. This may be information of a master information block. In one embodiment, it could be that RSS is not always transmitted at a fixed interval. In this way, other transmissions may take priority. As used herein, the term GPS information may refer to any Global Navigation Satellite System (GNSS) transmitter or receiver. Well known systems include, for example, Gonass, Galileao or Beidou, among others. These systems may be used for location detection, synchronization, tracking area management, registration among others. GNSS may be used to provide synchronization, either directly or indirectly, for example in time based on a reference clock. Other nodes may also provide synchronization, for example, a time or position server (for example alocation management server or function), an eNodeB, a gNodeB, or the like. Satellites may have a fixed or moving beam footprint.

Power control parameters may be provided via DCI. For example, power control values P₀, Alpha, power control loop, pathloss and the like may be determined by the service request identifier (SRI) field of a DCI.

Satellite based communication, or non terrestrial communication in non terrestrial networks (NTN) may or may be configured to support harq transmissions. That is, an NTN may enable or disable HARQ for one or more satellites via DCI or other longer term signaling. As an alternative to HARQ, a UE may adapt a redundancy or lower an MCS based on a satellite altitude.

A UE may prioritize synchronization signals. For example, if no synchronization signals are received from a gNB, the UE may search for a satellite based synchronization signal or vice versa. The UE may prioritize signals received via WLAN or beacons provided by other UEs as well.

Synchronization signals may include a primary synchronization signal and a secondary synchronization signal. These signals may be transmitted at different times and may indicate different portions of a variable length identifier of a base station, gNB, TRP etc. They may also be transmitted with different power levels from each other or from other signals. For example, the PSS or SSS may be transmitted at a different power level than the PBCH. It may be that the PSS, SSS and/or PBCH are each beamformed and/or transmitted in a sweeping manner. Other signals may also be swept either in uplink or downlink. The UE may receive the PSS, SSS and/or PBCH on a plurality of beams and determine which beam is strongest. PBCH may carry a master information block and/or secondary information block, i.e. a system information block (SIB). PBCH may be transmitted at a lower power level than SS (or vice versa). A plurality of PBCHs (or PDSCHs, PDCCHs, PUSCHs, PUCCHs) may be transmitted by a gNB (or a UE) which may overlap in time, frequency or beam. In one embodiment, a gNB mayor may not vary a DMRS sequence index for each transmission.

Vehicle specific parameters may be included in a MIN or one or more SIBs transmitted by one or more TRPs.

The MIB or one or more SIBS may include a UE which indicates whether or not a change in system information has occurred. This indicator may be a data structure which comprises a configuration change count including an integer number which wraps around once a maximum number is met. For example, an 8 bit configuration change count may wrap after 256 increments. A 9 bit may wrap after 512 and so forth. In another embodiment, the MIB may indicate a Boolean value that corresponds to a given time period. In this way, a UE may receive the Boolean value (bool, integer, bitmap, etc.) and determine whether or not a change has occurred based on the time it has not received recent system information. Bitmaps may be preferable when indicating status of a plurality of elements or parameters in a same indication. In an embodiment, a MIB or SIB may include a bitmap which represents which SIBs are transmitted or carried by the base station. There may be a bitmap which corresponds to other base stations as well, for example relay stations or stations of another technology/frequency. In another embodiment, the base station may provide system information change information of another node, base station or access point. This way, a UE may gain information about another node without having to reconnect. The another node or AP may be nearby the base station which transmits the information. In one embodiment, the information regarding change state of a base station may be relied by another network element. For example, a UE may be connected to a relay node which retransmits sync signals of a donor eNB. The relay node may be configured to indicate to the UE whether or not a MIB of the donor eNB has changed.

Information which may be provided from a node, for example a, donor eNB to one or more relay nodes and ultimately to a UE may be multiplexed via time, frequency or beam. Using time synchronization, a RN may receive synchronization information from a donor eNB and then immediately thereafter retransmit the information. An RN or gNB may employ time synchronization circuitry which synchronizes time among devices. Devices may be of multipls RATs, for example cellular, 802.11, or the like. Using frequency, the information may even overlap in time if the information is not changing rapidly. Synchronization signal blocks (SSBs) may be multiplexed by a relay node within a transmission time interval such as a frame or even smaller interval like a subframe. UEs may aggregate SSBs from relays and gNBs to determine position. SSBs may be located a plurality of symbols of a subframe. For example, SSBs may occupy portions of two slots, for example, first portions (i.e. including a first symbol), middle portions, not including a first/last symbol of a slot, or end portions (i.e. Including at least a last symbol in each slot. SSBs may change as needed or to avoid conflict.

A UE may measure a channel state information reference signal (CSI-RS), and SRS or a DMRS of a serving base station and/or a neighboring base station. The frequency of these measurements may be less for stationary or low speed UEs. The UE may respond with an RSRP, RSRQ and RS-SINR based measurement result. The response may be preceded with an indicator as to the type of measurement result response as well as a response quantity indicator. A UE may also rely on NZP CSI-RS. Measurements may be inter-frequency or Intra-frequency. Measurements may be taken during measurement gaps or gapless measurements may be made. Sometimes a UE may need to measure transmissions of neighbor cells and current/future serving cells so that applicability of a handoff may be determined. During carrier aggregation (intra band or interband) a single component carrier may be measured or multiple component carriers may be measured. Measurement results may indicate QoS measurements and/or actual network radio based measurements, CQI and the like. These measurements may be correlated and reported together. QoS reports may provide feedback for streaming services, for example, streaming based gaming, or lower priority data traffic. Streaming services include services which employ QUIC stream frames. Streams may be unidirectional or bidirectional and may be symmetrical or asymmetrical in data rate, size, QoS etc and may be set up, configured and/or cancelled based on measurements. A base station may transmit packets of streams based on the size, periodicity, and arrival time of the packets at the base station. A UE may report results of the radio based measurements to a base station of a same or differing technology with which it took the measurements from. Measurements and measurement reports may be based on quality of a frequency, quality of a time or quality of a beam or beams. The UE may be configured to report periodic measurement reports based on the type of base station, type of technology used, amount of frequency used or based on a beam or beams. Reporting may be group based and in this case, a signal may be broadcasted or multicasted. The report may be sent on a set of preferred beams.

Traditional gaming applications provide game commands to a game server. The game server may generate game worlds, levels, etc based on the commands. For streaming type gaming, video feeds may be provided directly to clients. The video feeds may be real time feeds comprising other game characters which are controlled by other live players also having video capable clients. There may be additional data which should be sent from the application server (or peer-to-peer) to a client which is non video data. For example, data may be location data, measurement data, feedback (for example tactile feedback). Feedback may also include information on other display formats or display angles which are capable of being generated by the game server and displayed on the client. When a game server provides a measurement object to the client, the client may perform the measurements indicated by the measurement object(s).

Measurements and measurement objects may be assembled which have to do with other radio access technologies. In one embodiment, a measurement object may be a data structure referring to an 802.11x type access network. For example a measobject may be a: measobject11ay for an 11ay RAT; a measobject11ax for an 11ax RAT; a measobject11ba for an 11ba RAT; a measobject11az for an 11az RAT; a measobject11aq for an 11aq RAT; a measobject11ak for an 11ak RAT; a measobject11aj for an 11aj RAT; a measobject11ax for an 11ax RAT. This may further be defined in granularity (frequency, time etc.) options for each reported object. It may be beneficial to report measurements based on band, for example, for 11ay specifically the high frequency bands, for example, 60 ghz bands.

Aggregated carriers may share power of the UE. For example, when transmitting two signals on two different carriers, a UE may be configured to not exceed a maximum power level. Some carrier may be licensed while others may be unlicensed carriers. A UE may perform RACH simultaneously with the different cells. If two PRACH signals are transmitted simultaneously, a max power may be exceeded. The same is true with other signals. The UE may be configured to split power based on a priority, a signal strength indicator, a distance to cell center, a QoS level of data being transmitted or the like. In one embodiment, a UE may be configured to limit power based on a capability (as defined by the capability ID). A UE may be configured to limit power based on a base station type or identifier. Two PRACH signals (or one PRACH and another uplink signal) transmitted by two different UEs may collide in time, frequency, beam, power or the like. In this case, the base station receiving the PRACH may perform interference cancellation to negate the unwanted uplink signal. Or the receiver may simply ignore the interfered portions in the time domain. Base stations may signal their capability to negotiate a PRACH configuration index. Neighbour base stations, which detect interference from each other, may signal a desire to separate PRACH configuration index or other spectrum/time portion or element so as to provide for fair service to UEs. These signals may be provided over backend/backhaul links such as Xn interfaces. The base stations may also negotiate an allowed PRACH preamble target received power. This target received power may be indicated to UEs from each of the base stations. In one embodiment, a base station may indicate an allowed PRACH preamble target received power for another base station. Base stations may also negotiate transmit directions of other base stations, for example, by indicating a direction, up, down, east, west, etc. In indicating transmission angles may be preferable. Two UEs which are in communication with a base station may support different PRACH configuration indexes. For example a SIB may indicate a limited PRACH configuration index to a first limited capability UE and a less limited PRACH configuration index (or no configuration index at all) to a higher capability UE. Essentially, the higher capability UE could transmit PRACH at any uplink instance. A PRACH configuration may apply to unlicensed spectrum. A PRACH procedure may be avoided in some instances, for example, if an estimate as to transmit power or transmit timing can be made based on position.

In an embodiment RACH may be unnecessary on handover when a UE maintains at least one network connection. For example, a network connection may be over WiFi, over a PCell, an Scell a SPcell, etc. On a condition that the UE is connected to the network, the UE may receive an RACH-less uplink grant on another network node. The UE may transmit at high power or with power ramping so as to transmit on the grant. At some point thereafter, feedback, including a TA may be provided to the UE. HARQ timing and other control parameters for the UL grant may be signalled on the network connection which is not handed over. In one embodiment, the UE may monitor the handed over cell to receive a TA and a resource grant. The control information may comprise frequency, time, beam or other control information. A new timer may also be configured for transmissions or retransmissions.

In one embodiment, a UE may measure beams transmitted by a TRP or panel prior to transmitting RACH. Some beams sent by the TWP may include reference signals for measurements while other beams include data transmissions to one or more other UEs. The measuring UE may determine a best beam, or a preferred beam, from the beams (or subset thereof) which are transmitted. The UE may maintain a list of beams or beam information as to which one of the beams have been successful and are likely to also be successful. The UE may transmit RACH on one or more beams simultaneously, or in time or frequency separated. The UE may maintain a number of failed attempts counter per beam for retransmission purposes. Retransmissions may have lower parameters, as compared to initial transmissions. For example, an MCS may be lower for a retransmission. Power may also be maintained and may be incremented per beam. Mobility state may be considered as well. For example a high mobility state UE may choose to delay RACH for a longer period of time as compared to a stationary UE. The information determined during the RACH procedure, for example the counters and beam information may be reported to the TRP, gNB etc.

Vehicles may be provided with information via base stations, other vehicles, satellites (e.g. GNSS based, GPS, etc). Vehicles may transmit information to other vehicles using a fully autonomous mode, e.g. one in which the transmitting vehicle selects the resources without being provided an indication from a base station. Other transmission schemes including semi-persistent schemes may be dictated by a base station or another device such as another vehicle, sign post, etc. Road side units like sign posts or street lamps (for example, multicolor LED lamps) may have working knowledge of a local congestion condition and may be useful in providing congestion information. UEs, signs, lamps, road side units, or the like may also provide location information to a UE. Signs, lamps and road side units may also be TRPs or incorporate elements of gNBs. In one example, a road side unit may pass a token to a UE which identifies the UEs location. The UE can then use this token to establish a location for receiving a location based service. In one embodiment, a UE attempting to determine location may rely on multiple transmitters to triangulate the position. This method may be secure in some embodiments. Base stations may be temporary or portable in nature. Base stations may be mounted on a movable device or on a tripod or pole. It may be that vehicles attempt to receive any incoming signal. However, there may be collisions. In the case of collisions, a UE may attempt to receive a packet from the strongest transmission point, or the UE may attempt to receive transmissions from weaker signals as well. It may be beneficial for a UE to have multiple antennas to alleviate the congestion. In addition, a UE may include a vehicle operating mode which is configured to receive multiple packets at once. The UE may have an interference mitigation processing unit interference suppression and cancellation may be used to perform the multiple packet detection (or even single packet detection).

If a NOMA transmission or reception collides with DMRS or another uplink control information signal such as an SRS or virtual SRS, the UE may drop the NOMA transmission or reception or alternatively drop the uplink control information, for example the DMRS or SRS. The dropping may be based on exceeding a maximum power or a period of time in which signals overlap/collide. The dropping may be based on an MCS or other parameter. However, the UE may determine whether to transmit (and may determine to transmit) at a maximum power in some embodiments. The signals may overlap in frequency, time, beam, layer etc. Dropping may or may not be applied to HARQ-ACK feedback, scheduling requests, channel state information, channel quality information, pre coding matrix indication, rank indication, layer indicator and beamforming or beam steering transmissions. Dropping may be based on a priority of the transmission and dropping may be based on whether an uplink (or downlink) signal was scheduled by a base station or alternatively is a periodic signal. Dropping may be performed when uplink control information cannot be multiplexed with a PUSCH transmission.

Sidelink transmissions may be aided in part from DCI information provided by a gNB. The gNB may indicate resources for: automatic gain control (AGC), PSCCH, PSSCH, guards and a physical sidelink feedback channel (PSFCH). The PSFCH may be used for CSI feedback and beamforming feedback and may be compressed. The PSFCH may also be used to indicate UE capabilities for renegotiation of resources or to signal enhanced capabilities. Sidelink transmissions may include a S-PSS and S-SSS which may be distinguished from PSS and SSS of a gNB based on length, frequency, amplitude, phase, modulation type/format or the like. In one embodiment, a symbol length may be longer than that of the PSS. Amplitude may be lower, modulation type may be distinct, etc. A gNB may provide resources and other information for detecting an S-PSS and/or S-SSS.

Carrier aggregation in new radio may be more complicated than in LTE. In new radio, carriers may be activated, becoming activated or dormant. For each one of these states, CQI reporting may be treated differently. Timers may be utilized for measurement purposes. CQI may be reported based upon a threshold. For example, for any component carrier (active, IDLE or inactive), it may be beneficial to only use uplink resources for transmission of an indication of CQI for a preferred (or greater than threshold) carrier. In one embodiment, uplink resources may be determined autonomously by a UE. The determination may be in part by information receives via RRC signaling and in another part by measurement taking. Measurement periodicity may be provided in a sib, for example SIB5 and/or the UE may determine to alter the measurement periodicity autonomously. An R16 SIB5 may indicate additional information like priority, time, rat type etc. A type of measurement may also be indicated as well as information about one or more neighbor cells. This may be indicated for current cell and target cell. A SIB may indicate frequencies for measurement, for example, 3, 4 or 5 particular frequencies. Upon activation, a dormant cell may be considered active and may be deactivated subsequently at some point. An active cell may become dormant. Scell parameters may be provided by higher layer signaling, for example RRC signaling. Scells may be activated via MAC layer signaling, for example a MAC CE. In an embodiment, a UE may send a request to a gNB, to activate an Scell. The request may be based on or may indicate a QoS priority, a file size for upload/download. The request may specify a time period (time, number of symbols, offset etc) with which the UE would like the SCell activation to be provided. SCell activation may occur via DCI or MAC CE on a cell which is no the SCell. A MAC CE may also contain URLLC data in addition to the SCell activation or any other MAC CE command.

For cell access or random access, a UE may be configured with a random access occasion mask index. This mask index may dictate allowed RACH occasions. RACH occasions may be indicated via DCI of another carrier.

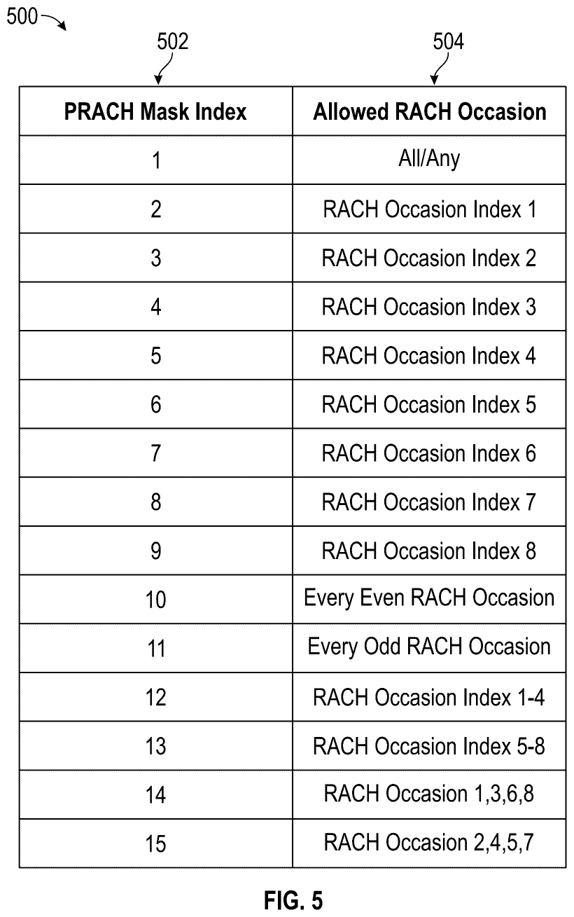

FIG. 5 is a RACH occasion table 500. A mask index 502 may indicate a corresponding allowed rach occasion format 504. In particular, the mask index 502 may relate to a unique RACH occasion of a plurality of potential RACH occasions; the mask index 502 may relate to an even or odd RACH occasion; the mask index may relate to a first half, for example RACH occasion index 1-4; a second half, for example a RACH occasion index 5-8; or alternatively, a combination of RACH occasion indexes which is other than even/odd or uniquely specified. A UE may be capable of power ramping during random access. Additionally, a UE may be capable of beam cycling for each power level. TRPs may also be capable of beam cycling using transmit or receive beams. For example, when receiving transmissions or retransmissions, beam cycling may be employed.

RACH procedures may occur over one, two or more steps. The UE may transmit a preamble (for example, using an index selected randomly between 0 and 63), before a RACH transmission or data transmission. In one embodiment, a UE may send a payload with a preamble, for example, a single bit payload may be provided. The payload may include a request for one of a plurality of system information blocks. Alternatively, the payload may indicate a plurality of system information blocks or information elements requested by the UE.

Including a payload with an initial transmission may be done in licensed or unlicensed frequency bands. Feedback may then be provided by the base station. The UE may then send a second preamble with a payload. The preamble may be sent with a multiple access signature using any one or more of the multiple access schemes disclosed herein. The MA scheme may have random number input, i.e. a random number may be identified as an input to a pool of resources. A first random access preamble may be transmitted on a licensed or unlicensed bandwidth, then the second random access preamble may be transmitted on an opposite one. After initial RACH, RRC signaling may occur, for example connection setup messages may be exchanged, i.e. received by the UE and confirmed via acknowledgement. Connection setup messages may be authenticated and/or integrity protected. For example, any one or more of the parameters disclosed herein may be included in the connection setup messages, and each one may be protected, encrypted. A two step RACH procedure may include: transmitting a msgA with a preamble in a same or different slot with time domain multiplexed payload, wherein the msgA include transmission parameters, for example, MCS, power, resources of other uplink control information in the payload portion; receiving in a msgB, a set of resources to monitor; and monitoring the PDCCH (for example, monitoring 1, 2 or 3 consecutive symbols) for a DCI. In on embodiment, parameters of the data portion may be indicated by the selected preamble or resource for transmission. In this way, a gap may be needed for the gNB to decode the data portion. The data portion may be scrambled with the random access RNTI. The time payload of msgA may comprise the UE capability ID, a UE identifier, UCI or any other information herein. msgB may also include a payload, timing advance and/or UE ID used for signaling DCI or for other purposes. msgB may have a unicast and multicast or broadcast portion. The preamble selected by the UE may have preassociated resources for the data transmission. Some preambles may indicate contiguous resources while others indicate noncontiguous resources. The preamble selected may also indicate MCS, number of resources for data transmission or any other parameters disclosed herein. The DCI may indicate PDSCH resources which provide a MAC CE or other data. A fallback to 4-step RACH may also be performed. The RAR window time may be an offset considering: a first symbol of MsgA, the last symbol of MsgA including data, the last symbol of the preamble, the first symbol of data. The UE may transmit a midamble, for example, in between data transmissions of one or more frames or PPDUs. The midambles may comprise one or more signal (SIG) fields, legacy training fields (LTF) fields or new training fields. Midables may be placed within differently modulated or coded segments, which may also have different power levels, of a PDU. Midambles may provide NOMA interference cancellation parameters or any other data or parameter as disclosed herein. A RAR window may be extended beyond 80 slots and may extend upwards of 10 ms or more if the RAR is configured to occur in an unlicensed band. The RA-RNTI may be computed based on any parameter disclosed herein. Training fields may be secured by a key.

In a RACH procedure, the UE may consider determining whether a received timing advance is valid. The UE may do this by receiving synchronization signals and attempting to determine a relative timing advance from sync. In one embodiment, the UE may apply different timing advances for different uplink transmissions, for example transmissions on the PUCCH, PUSCH, RACH, sidelink channels or the like. For example, for RACH, the UE may have no timing advance information and may transmit the RACH successively with different timing advance values chosen. The UE may use a gap or guard period to adjust accordingly. The gap or guard period may be indicated to the UE, for example, number of symbols between uplink and downlink, or between two downlink or two uplink signals, etc. Block interlacing may be applicable to any one of the uplink transmissions, for example the PUCCH, PUSCH, RACH, sidelink channels or the like. This way a plurality of short transmissions may take place over a single lengthy transmission. The embodiments disclosed herein with respect to dropping may still apply to interlaced transmissions. As well as gap or guard time periods, gaps in frequency may be employed, in some scenarios.

A UE may be provided with RACH resources, for example, time/frequency/beam resources for a RACH transmission in a DCI format 6_0, DCI format 6_1, DCI format 6_2 or 6_3, in one embodiment. Alternatively, or in combination, any DCI herein may signify the RACH resources used by the UE. For example, a UE may supply a pool of resources, or at least a plurality of resources and the UE may perform LBT and/or random selection of the resources. The UE may reserve resources of the pool following LBT and/or resource selection.

When a UE enters an idle mode, the UE may receive a configuration for grant free transmissions. This configuration may be received over RRC or other signaling along with any of the parameters disclosed herein. Another consideration of grant free transmission may be a sense before transmit operation. The UE may sense a channel for occupancy. The UE may be configured with or scheduled with a channel occupancy time (COT) or times (COTs). Each one of the COTs may be used to UL or DL traffic and HARQ feedback. The HARQ feedback may be of transmissions in earlier COTs. The UE may be configured with a backoff timer such that upon sensing the channel busy, the UE may wait a backoff time before proceeding. The backoff time may correlate to a type of data transmission, a level of importance and/or a UE capability/type. NOMA or other grant fee transmissions may precede grant based transmissions.

In some instances, such as high channel occupancy instances, traditional carrier sense multiple access may or may not be enough to ensure fairness of a channel. Instead, a coordinated method may need to be employed where a transmitter (non-AP STA or AP STA) becomes a transmission coordinator for congestion control/mitigation. In other embodiments, a controlled access phase may be used instead of CSMA. In some embodiments, longer backoff times may be necessary for each STA in order to maintain a channel. In an embodiment, a carrier may be accessed when no transmission is heard in a certain direction. If, for example, a transmitter transmits in a direction for a given time period and then backs off for a set period, another receiving station may recognize when the backoff period will occur and thus can be aware of a transmission opportunity. This can be direction oriented, i.e. a number of transmission in a certain direction may give way to an opportunity. Alternatively, a coordination mechanism, provided by a gNB other other device (road side unit, etc), may act as a coordinator. Transmissions may be scheduled via SIB or other means.

In an embodiment, a SIB, such as a SIB5 may carry timers for measurements made by a UE. The timers may include a validity timer for use by a UE in an IDLE mode (or in any other mode). Other timers may be used for dormant state UEs. Timers may be applicable based on an area of which the UE is in. For example, timers and other SIB information may be applicable to certain UEs of a cell, while not other UEs of the same cell. Some SIBs may or may not be transmitted by a cell.

A UE may be in simultaneous communication with an LTE cell and an NR cell (and/or any other cell for that matter such as Wi-Fi, Bluetooth etc.). In any event, a UE may be referred to as in dual connectivity, multi connectivity or may simply be said to have a supplementary uplink (or downlink) connection. The supplementary connection may require reports transmitted to the main (or supplementary) cell. In one embodiment, intra-frequency measurements may be gapless, while inter frequency measurements may be gapped (e.g. the UE is supplied with a gap time). The gap time may be a period of time measured in ms 0.25x wherein x is an integer between 6 and 24.

Dual (or other) mode UEs may be connected to both a core network of a cellular system, the core network operating on a sliced network approach, e.g. using network slicing. Base stations of the sliced network may supply information and data to the UE via a quality of service which is priority based. A priority may be indicated based upon a channel, a traffic type or may be flow based. Dual mode UEs may be connected to both a 5G core network and a legacy evolved packet core of a 4G based system. Dual modes may be dual cellular, e.g. dual licensed connections or cellular/wlan combinations. Carriers may be aggregated between the both technologies. It may be beneficial to provide an indication of a network slice used by the UE to the UE. This may occur via RRC, MAC or other signaling methods.

Cellular systems may include time division duplex (TDD) and frequency division duplex (FDD). In FDD systems, a UE may be both transmitting data and receiving data at the same time using different frequencies. Next generation systems may be more flexible in nature, thus allowing UEs to and cellular networks to determine duplexing schemes in a dynamic fashion. In this way, an optimum duplexing configuration may depend on traffic volume and quality of one or more links between the UE and the base station. UEs may operate in half duplex or full duplex mode in accordance with a traffic type, data priority, power level or the like. A mode may change, for example, for watching a movie, a UE may need substantial downlink resources with minimal uplink resources. Thus, a TDD mode may be employed. Of the UE switches to a two way video application, a 1:1 uplink/downlink allocation may be employed, and the network may instruct the UE to enter a FDD mode. A UE may be provided with a half-duplex pattern similar to a DRX pattern. The UE may switch to TDD from FDD and vise versa according to the pattern. The UE may provide feedback as to buffer status, etc. which may indicate whether the pattern needs to be adjusted. The pattern may also be adjusted based on signal-to-noise ratio and/or how much interference is occurring etc. For example, an interference level may be measured on a subband and if that interference is high, while the need for the subband is low, the UE may autonomously switch to abandon the subband. A switch to FDD may be determined based on a new multiplexing need, for example, additional data becomes available for transmission.

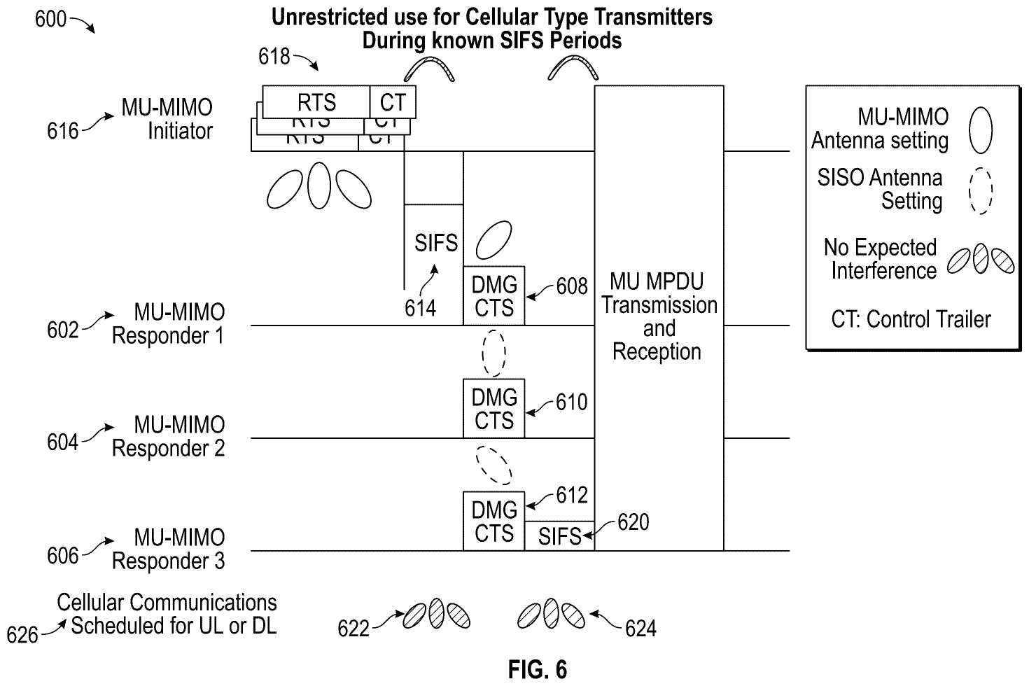

FIG. 6 shows a standard 802.11ay draft procedure 600 in which MU-MIMO responders 602-606 transmit clear to send responses 608-612 a SIFS 614 after at known initiator 616 transmission 618. After the CTS provided 608-612 by each responder 602-606, one or more SIFS periods 620 are provided for responders 602-606 to switch from uplink to downlink and receive or transmit one or more MU MPDUs. The SIFS periods 614, 620 shown in FIG. 6 are periods in which can be dedicated for other transmissions of other technologies such as new radio unlicensed (NR-U). These SIFS periods may be used for very short transmissions 622, 624, for example, a control transmission of a cellular type transmitter or receiver 626.

CTS-to-self messages may be used to determine when SIFS periods are scheduled based. Once a UE recognizes a particular standard using 802 or other technology standard, it may be possible to automatically detect the SIFS periods and transmit/receive accordingly. Support for a given standard should of course be provided to a base station.

A UE may receive an LBT configuration from the gNB. The UE may use the configuration to sense the channel in coordination with the gNB such that transmissions are scheduled when both the gNB and the UE detect a channel busy ratio below a threshold. In this way, the gNB may not block short range transmissions near to or of the UE. In an embodiment, other UEs near the UE may not be co-scheduled, while UEs not near the scheduled UE may be co-scheduled.

A UE may avoid LBT when needing to transmit a high priority message, for example a HARQ acknowledgement. No LBT may be supported for certain frequency ranges, for example, for frequency bands including 2.4 hz, 5 ghz, 5.9 ghz and 6 ghz or others. In other embodiment, a UE may not avoid LBT and the UE may a decision to switch bands or channels upon determination of a channel busy state. A DCI format or other format may indicate primary uplink transmission resources and backup resources in case of LBT failure. A maximum number of LBT failures, for example, on one or more 20 Mhz channel, may be configured and a determination as to whether this number is met may be made based on a sliding time window, a counter, timer or the like. In one embodiment, a UE may delay transmission on indicated resources. For example, the UE may transmit on a later in time resources, but not a first portion of the resources. A UE may transmit on a portion of frequency resources.

Latency compatibility may be an issue in NR. One particular goal of NR is to reduce latency to 1 ms or below. A number of enhancements may support achieving this goal. One such enhancement may be to support blind PDSCH repetition. This may be achieved using legacy PDCCH or PUCCH formats. There may be no HARQ performed in a blind repetition. In other scenarios, UEs may operate on a best effort only policy. Blind configurations may be only applicable to secondary cells, for example cells which are not a primary cell of the UE. Secondary cells may be 802.11 based, Bluetooth based or even cellular or other network carrier based. There are many ways in which secondary cells could be employed: any potential secondary cell (on any frequency known to the UE) might be measured. These measurements might be reported in idle mode. It may even be possible to signal an SCELL measurement report on the SCELL. For example, some networks might allow a measurement to be reported prior to the UE performing an association procedure with the SCELL. This might also provide signaling for the end-to-end latency to be received by a component of a PCELL or another network node. Consider the delay not being of the RAN, but potentially of the underlying wireless network. In this case, only limited RAN resources would be utilized if the wired network is determined to be congested.

Control channel and shared channels have typically been split in prior art systems. In some designs, the locations of control, for example PDCCH, and PUSCH or PDSCH may be interleaved. Transport blocks may be interleaved on any one of these or other channels. For example, if there are any unused or unnecessary resource elements dedicated to PUCCH, they may be configured as PDSCH RBs. In this way, a base station may be able to signal data to a UE in a same subcarrier or a subcarrier only a short time frame away. This may be implemented only if a UE is configured to always receive X symbols in time, wherein X is means the 0 through X symbols in the first subcarriers or a slot, subframe, etc. Resources, for example, for PUCCH or PUSCH may be determined or selected based on a combination of payload size or payload data type. A UE may have a capability indicator which indicates capability to receive a downlink shared channel in a different slot or subframe than the downlink control channel. The capability may indicate a number of simultaneous PDCCH, PDSCH, PUCCH, PUSCH, PRACH or other channel transmissions which may be supported in time. Another capability may relate to an ability to receive a plurality of downlink shared channels indicated by a downlink control channel on a different frequency and on a different slot or subframe. The UE may be configured to monitor for downlink control channel in a particular time/frequency resource(s). For example, a UE may be configured to monitor for a PDCCH at a subframe, slot, mini-slot which may be configurable based on DCI or MAC signaling. The UE may be configured after transmitting a PDCCH monitoring capability indication. This monitoring configuration may be changed dynamically (on either an unlicensed band or a licensed band) and may depend on a type of control information. A gNB may indicate a gap period of which no PDCCH monitoring must be performed. This may be indicated per period or over a time period using a bitmap or via a duration indication. The monitoring capability may be provided in DCI and may be a set of one or more configured timers for monitoring PDCCH, not monitoring PDCCH, skipping reception of PDCCH etc. CCEs may indicate for the UE to skip x symbols, or x slots, or the like. Different numbers of CCEs may be monitored in a slot based on capability. A capability may relate to an ability of a UE to process downlink or uplink after receiving an indication of the resources for such transmission. A UE may employ another timer to sleep for a period of time between PDCCH reception and subsequent data reception or transmission.

A UE may out of order process downlink resources->uplink transmission, for example, by performing out of order HARQ operations. A UE may be scheduled for transmissions out of order HARQ for processes that vary in terms of priority. For example, a UE may receive a HARQ ACK for a second (or subsequent) transmission prior to receiving a HARQ ACK for a first uplink transmission. This may be due a higher priority of the second uplink transmission. This may be based on an MCS of the first and second transmission. For example, higher MCS may be ACKed first or subsequently.

In an embodiment, PDSCH may have an associated priority indicated in the transmission or in the DCI indicating the transmission. If two PDSCHs collide in the time domain and are not be multiplexed, the UE may only decode the higher priority of the pair of PDSCHs.

A UE may be capable of supporting out of order PDSCH reception, out of order PUSCH transmission, out of order HARQ transmission for received PDSCH and/or out of order HARQ reception for PUSCH. Out of order HARQ transmissions may be out of order based on transmission priority or HARQ identifier. A UE may be capable of processing two or more NACKs or ACKS together based on two different HARQ processes. Out of order processing may occur based on a BWP (default or configured), numerology, SCS, gap size, number of overlapping symbols of the transmissions or the like. Regardless, the UE should always decode the PDCCH and determine priority before making a decision on a HARQ ack procedure. The determination may be in accordance with a serving cell, secondary serving cell, number of serving cells or the like.

Wireless communication environments may include light based environments. Modulation types, for example, may include asymmetrically clipped optical OFDM (ACO-OFDM), DC biased optical OFDM (DCO-OFDM) and asymmetrically clipped DC biased optical OFDM (ADO-OFDM). Any one or more of these modulation types may be used for light based environments. A transmitter may indicate a switch to another OFDM type. In many home and commercial environments, lamps have shades and windows have window dressings (curtains, blinds, shades, etc). In one embodiment, a translucent material is employed in place of the blind or lamp shade. The translucent material may be comprised of a twisted nematic or light based devices that polarize light. In this way, the polarizers may be set to correspond to a particular translucency and cause dimming. Given that the polarizers are electrically actuated, a control circuitry may cause them to intermittently transmit data while also blocking light. A visible light transmitting device may be configured as an scell or master cell. A visible light receiving device may rely on a photodiode or camera for receiving light signals. A photodiode may, for example, receive signals (for example MIMO based) and provide them to a filer (low-pass, high-pass) for separating and providing output data and any light output. A photodiode may be used to measure channel characteristics, i.e. signal to noise ratio(s) and the receiver may report the SNR to the transmitter to adjust bitloading. Bitloading may be done based on time, frequency, movement, angle, color, intensity or the like for light based methods. Bitloading may be adjusted with respect to RF transmissions based on feedback received over one or more light transmission(s) or vice versa.

A capability of the photodiode or camera may need to be assessed and reported in order to receive transmissions accordingly. For visible light communication (or any other communication for that matter, a UE may report a capability to support any one or more of the following codes or coding schemes: Hierarchical Codes; LCD to camera Manchester coding; BCH Code; Alpha channel coding; RGB coding; Overlay coding; Quick response (QR) codes; Interframe Erasure Codes; QR codes; Robust dynamic coding; Rainbar coding; Rateless coding; Texture codes; Alpha39 coding; Manchester coding; Raptor Codes; Reed-Solomon coding; binary convolutional coding (BCC). Supported modulation techniques may include: Wavelength Division Multiplexing (WDM); Pulse Width Modulation (PWM); Phase Shift Keying; Under-sampled Differential Phase Shift On-Off Keying (UDPSOOK); On-Off Keying (OOK); Quadrature Phase Shift Keying (QPSK), Color shift keying (CSK); Under-sampled Frequency Shift On-Off Keying (UFSOOK); Under-Sampled Quadrature Amplitude Modulation with Subcarrier Modulation (UQAMSM); 16QAM; 64QAM; 128QAM; 256QAM; 512QAM/1024QAM; 2048QAM; 4096QAM; Hybrid OOK-PWM; Spatially-Modulated Space-Time (SM-ST); Layered Space-Time Code (L-STC); Spatial-Temporal Complementary Frames (S-TCF); Pixel translucency modulation; Spatial Discrete Multitone (SDMT). PDUs may indicate modulation scheme in a preamble. Modulation schemes may be indicated in the alternative, i.e. one or another. Any scheme may by hybrid in nature and employ a combination of two or more schemes. For example, a single packet, frame PPDU, or the like may employ multiple (for example, 2-3) modulation methods wherein a first modulation method is a lower speed/coding than a following modulation method. The second (or third) portion may be sent with a higher or lower power or at a different beam or angle, etc. In an embodiment, a combined analog/digital method may be employed. Any one of these modulations techniques and coding techniques may vary as the transmitter employs HARQ. Any one may change based on a redundancy or redundancy version for transmission.

Circuitry may include one or more of a circular buffer, multiplexor, first in first out buffer, last in last out buffer, last in first out buffer, strings, memory, state machines, Multiplexer/ALU, priority queue, microprocessor, registers, microcode, threaded pipeline, bus, field programmable gate array (FPGA), application specific integrated circuit (ASIC), baseband processor, video processor or other electronic circuit for that matter. Logical calculations may be performed on any parameter or parameters. ANDing, ORing, XORing, or the like may be performed in a logical or Boolean fashion. Circuitry may include interleavers such as LDPC block interleavers. Circuitry may be configured to generate a random number as input or compute a modulus operation. Circuitry may include equalizers for interference cancellation or other techniques. Equalizers may include spatial temporal linear equalizers including zero-forcing (ZF) and minimum mean square error (MMSE). Circuitry may also include amplifier(s) such as a power amplifier. Video circuitry may include a video processing unit (VPU) and a graphics processing unit (GPU). A display may be coupled to the GPU. Circuitry may include ciphering and deciphering circuitry. Circuitry may refer to buffer, for example, a time sensitive networking buffer which may be supported by a UE or STA.

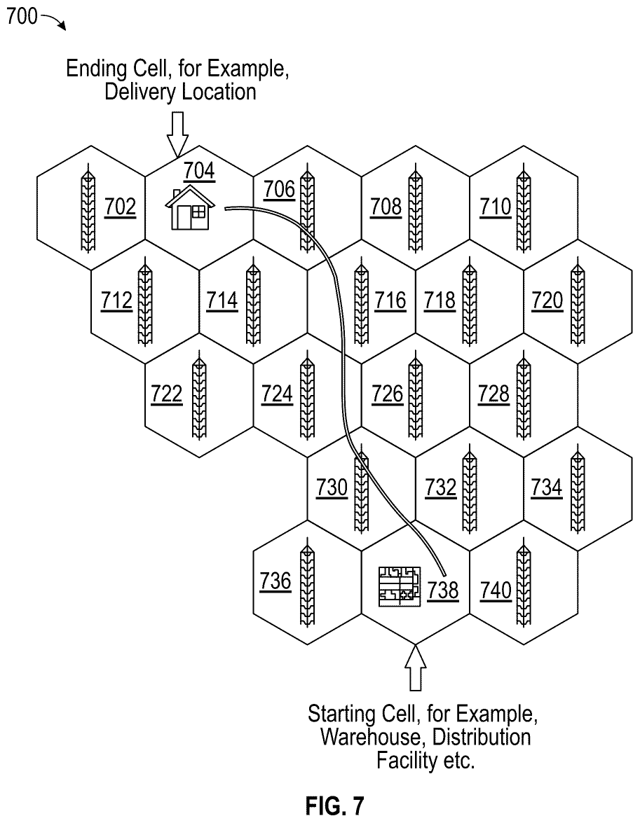

FIG. 7 illustrates an exemplary UAV or UE or even vehicle which follows a route from a distribution center to a drop off point. In one embodiment, a UAV may maintain a listing of base station identifiers between its origination point and destination point. By maintaining this list, the UAV may be able to save on measurement reporting. In one embodiment, a listing of base stations may be developed via previous flights from origination to destination or from origination to a point beyond the destination. If the UAV is also a radio access node on-board UAV (UxNB), the UAV may participate in negotiating and scheduling transmission blanking intervals, no transmission intervals/periods and reference signals based on location and position signals received from the base stations flown over. The UxNB may transmit reference signals to indicate location to base stations so that transmissions may be coordinated.

FIG. 7 indicates a flight pattern 700 of a drone through cells 702-740. As shown in FIG. 7 a drone may take flight in cell 738 which may be a warehouse, distribution facility or the like. The drone may navigate through cells 730, 724, 716, 706 to reach a destination cell 704. In an embodiment, the drone may serve internet access or data access to UEs which are ground based. The drone may navigate to destination cell 704 based on a location of one or more UEs which need data access from the drone or UAV. In an example, instead of entering cell 724, the drone may enter cell 726 to serve data to a UE located within that cell. In an embodiment, a drone may fly a route which corresponds to cells for which it needs data access or may be using for data transmission. For example, the drone may enter cell 716 instead of 714 if cell 714 is inaccessible or restricted to the drone.

Other exemplary applications include railway applications which include similar embodiments. In one embodiment, a railway car or train may transmit signals via the rails to a relay which relays them wirelessly. In another embodiment, a train may transmit directly to a base station. Trains may need to communicate when a potential problem exists, for example, a mechanical failure, a light is out, a track is observed to be obstructed. These conditions may be threshold based, and communication may be based on a threshold. Other needs for communication may be due to maintenance, location detection or diagnostics. Trains may communicate with track equipment and other equipment. Trains and train track equipment may be equipped with a wireless transceiver for this purpose. Automatic train commands may be issued to trains or track equipment. Both may indicate location, capability and may perform synchronization and the like. Transmission of RF signals may switch between wireless RF transmissions to a base station and track based signaling, based on determination of any radio conditions. Track based communications may be RF to track or elements near track, power rail modulation (signal transmission over the train power supply), or via wheel to track, train to interlock or vice versa, or the like. A switch in transmission or reception type may occur based on any signals or parameters as disclosed herein. A switch or a switch to a redundant operation may be based on signal quality, train location, train speed, detection of a drowsy operator or any other fault or error condition. Communication diversity or switching may be to visible light spectrum, ultraviolet or other light based methods. A train may be configured to transmit in a redundant fashion, for example, using any one or more of track based transmission, transmission over single power rail, wireless transmission, wireless relay transmission (via a lamp or other base station, for example), via light based communication, satellite based communication or to/from a UAV. A UE may support multiple different diversity transmission schemes or methods for example using cyclic delay diversity (CDD) or other methods. Support for a number of schemes may be indicated. A single DCI format may support the different schemes supported by the UE.

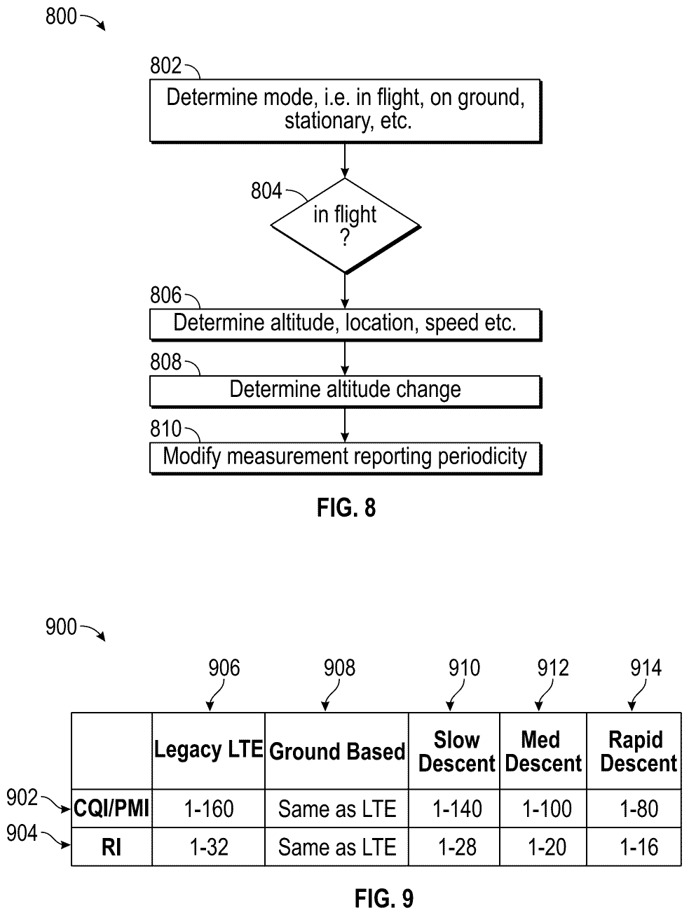

FIG. 8 and FIG. 9 illustrate a line of sight concept. In one embodiment, a UE may report energy efficiency, imperfect CSI, number of channel estimation errors, partial CSI and other limited channel feedback, for example 1 or 2 bit feedback. Feedback type may be indicated, along with the resources for the feedback, in any DCI format message. A UE may need time to compute feedback and may not transmit feedback if time does not allow for it. A UE may perform Data-Aided Channel Estimation (DACE) and or Midamble Channel Estimation (MCE).

In FIG. 8, a flowchart 800 is provided for determining measurement determining and reporting periodicity. For example, a UE may determine a mode of flight 802, i.e. on the ground or stationary, or in flight. If the UE is in flight 804, am altitude, location speed or the like may be determined 806. If there is a change 806 in altitude, location or speed, the UE may determine 808 the change. Based on a look up table or other means, the UE may modify the measurement reporting periodicity 810. The UE may be configured to take more or less measurements based on speed, altitude change or the like.

FIG. 9 is a table 900 which illustrates examples corresponding to descent scenarios. A ground based unit may report CQI/PMI 902 and RI similar to that of LTE 906. For example, a legacy LTE device 906 may report CQI between 1 and 160 subframes. A UAV may receive a configuration via RRC signaling and use this configuration to determine periodicity for measurement reporting. In legacy LTE 906, CQI/PMI 902 is reported between 1 and 160 subframes. RI is reported between 1 and 32 subframes. In one embodiment, depending on the speed of descent (or ascent) of a UAV, reporting periodicity may be either increased or decreased. This is because radio conditions may improve (or get worse) with altitude, i.e. the UAV may have a better (or worse) line of sight to a base station or other receiver/transmitter. Descent may be measured in three different intervals, for example, slow decent 910, medium descent 912 and rapid descent 914.

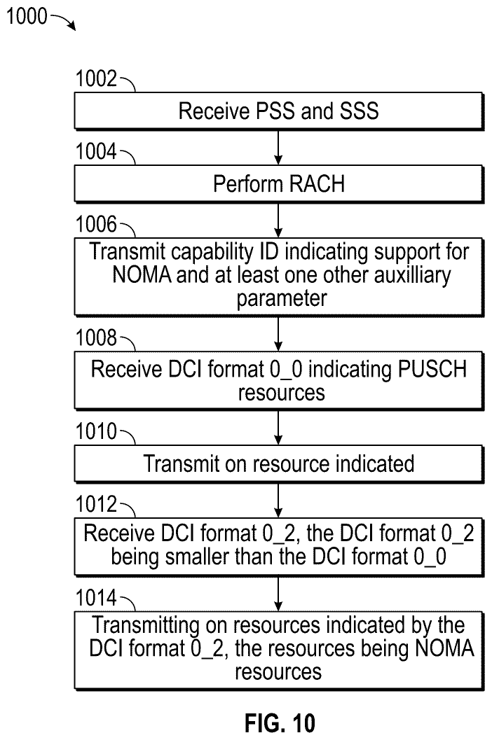

FIG. 10 is a flowchart 1000 for receiving resources for NOMA transmissions by a UE. The UE may receive a synchronization signal 1002, for example a PSS and SSS. The UE may also receive a resynchronization signal at some point, which differs from the PSS and SSS. RACH may be performed 1004. The UE may indicate support 1006 for NOMA transmission capability along with at least one other parameters of the UE. The another parameter may be unrelated to the capability to support NOMA. The UE may receive 1008 a DCI format 0_0 indicated PUSCH resources for transmission. The UE may transmit 1010 on the PUSCH resources and subsequently receive a DCI format 0_2 1012 which has a total number of bits which is less than the total number of bits used for the DCI format 0_0. Any DCI format herein may be specified with the smaller number of bits by comparison to another disclosed format. The UE may then transmit and/or receive on 1014 the indicated resources of the DCI format 0_2.

What is claimed is:

1. A method performed by a UE, the method comprising:
receiving a first synchronization signal, from a base station, and decoding PBCH by way of the first synchronization signal;
receiving RRC information, from the base station, wherein the RRC information indicates information about a second synchronization signal which is different from the first synchronization signal;
determining a periodicity of the second synchronization signal based on the RRC information;
receiving, on a secondary cell (SCELL) of the base station, the second synchronization signal in accordance with the periodicity;
receiving a measurement gap configuration;
receiving first downlink control information (DCI) that schedules resources over more than one set of frequency domain resources, wherein the first DCI comprises a single bit flag which indicates skipping of a set of symbols;
skipping, at least one measurement gap due at least in part to a higher priority signal in accordance with an offset from the first DCI.

2. The method of claim 1, wherein the measurement gap configuration is received on the SCELL.

3. The method of claim 1, wherein the skipping is based on the DCI.

4. The method of claim 1, wherein the second synchronization signal has a different frequency.

5. The method of claim 1, wherein the first DCI is received on a TDD carrier.

6. The method of claim 1, further comprising receiving second DCI on the TDD carrier, wherein the DCI indicates that the UE is to make a switch to a FDD mode on the TDD carrier.
